(19) United States
(12) Patent Application Publication
(10) Pub. No.: US 2006/0280488 A1
(43) Pub. Date: Dec. 14, 2006

(54) Reproduction apparatus

(75) Inventor: Akihiro Tanabe, Minato-ku (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/445,989

(22) Filed: Jun. 2, 2006

(30) Foreign Application Priority Data
Jun. 10, 2005 (JP) 2005-171006
Apr. 3, 2006 (JP) 2006-102091

(51) Int. Cl. H04N 5/00

(52) U.S. Cl. 386/126

(57) ABSTRACT

At least one exemplary embodiment is directed to a reproduction apparatus, configured to transmit image data to a signal processing device that records data on a second disc, which includes: a reproduction section configured to reproduce the image data from a first disc; an instruction section for instructing image data transmission to the signal processing device; a communication section configured to receive disc status information including information indicating whether the second disc is a rewritable disc or a write once disc from the signal processing device; a determining section configured to determine whether the image data can be recorded on the second disc on the basis of the disc status information; a display section configured to display a determination result of the determining section and the disc status information; and a control section configured to control the reproduction section to reproduce the image data from the first disc and to control the communication section to transmit the reproduced image data to the signal processing device.

### BACKGROUND OF THE INVENTION

1. Field of the Invention

The present invention relates to a reproduction apparatus, and more specifically, though not exclusively, to a technique of transmitting information data reproduced from recording media to an external apparatus to record the information data on other recording media.

2. Description of the Related Art

Up to now, a digital camera, a video camera, and other related or equivalent apparatus are known as an apparatus that records and reproduces picked-up image data in a memory card, a magnetic tape, or other storage device, as digital data. Also, in recent years, a disc video camera has been on the market that records and reproduces picked-up image data on an optical disc such as a DVD.

The optical disc and the memory card used in such a disc video camera are equivalently expensive. Therefore, after the recorded image data is copied on large capacity recording media, the original disc data is deleted to use the disc repeatedly.

To be specific, the image data recorded on the optical disc or the memory card is transmitted to a personal computer (PC) and stored in a large capacity hard disc drive (HDD) or an optical disc built in or mounted to the PC (for example, refer to Japanese Patent Laid-Open No. 2002-082777).

In this case, a user connects the PC, the digital camera, and the video camera to one another via a high speed serial interface such as USB or IEEE1394, to transfer the data recorded in the memory card or the optical disc to a large capacity recording device that is built in or mounted to the PC for data storage. At this time, in general, the user can use an application running on the PC to specify and execute the data transfer from the source recording medium to the large capacity recording device.

As described above, in order to transfer the data recorded on the disc mounted to the video camera to the large capacity recording media in the PC for the data storage, the user needs to operate a data storage application on the PC side.

Such an operation related to the PC application can be complicated and the control can be bothersome for a user who seldom uses a PC.

That is, it would be useful for the user to transfer the data that has been recorded on the mounted recording medium to the large capacity recording device for the data storage only by operating the video camera without the operation of the PC.

### SUMMARY OF THE INVENTION

At least one exemplary embodiment is directed to an imaging apparatus where the picked-up image data stored on a data storage device (e.g., disc) in the imaging apparatus, is stored on another large capacity recording medium upon operation by a user of a function in the imaging apparatus, where the data recorded on the data storage device can be deleted and used again. Additionally the imaging apparatus, in accordance with at least one exemplary embodiment, can provide visual indication to a user that the completion of transfer, recording, and storage without problems has occurred.

At least one exemplary embodiment is directed to an apparatus with which, when information data recorded on a recording medium is transmitted to an external device to record the data in another recording medium, a status of the external device can be easily recognized and contemporaneously the information data transmission and recording process can be simply controlled.

At least one exemplary embodiment is directed to a reproduction apparatus communicable via a transmission path with a signal processing device that records data on a second disc recording medium by controlling a recoding device, including: a reproduction device configured to reproduce image data from a first disc recording medium; an instruction device configured to instruct the signal processing device to transmit the image data reproduced by the reproduction device to be recorded on the second disc recording medium, the second disc recording medium including a rewritable recording medium on which data can be repeatedly overwritten and a write once recording medium; a communication device configured to receive disc status information related to the second disc recording medium from the signal processing device, the disc status information including information indicating whether the second disc recording medium is the rewritable recording medium or the write once recording medium; a determining device configured to determine whether or not the image data can be recorded on the second disc recording medium on the basis of the disc status information; a display device configured to display a determination result of the determining device and the disc status information; and a control device configured to control the reproduction device to reproduce the image data from the first disc recording medium in accordance with an instruction from the instruction device and control the communication device to transmit the reproduced image data to the signal processing device.

Further features of the present invention will become apparent from the following description of exemplary embodiments with reference to the attached drawings.

### BRIEF DESCRIPTION OF THE DRAWINGS

FIG. 1 shows a schematic of a recording/reproduction system configuration to which at least one exemplary embodiment is applied.

FIG. 2 shows a schematic of a structure of a video camera according to an exemplary embodiment of the present invention.

FIG. 3 shows a schematic of a structure of a PC according to a first exemplary embodiment of the present invention.

FIG. 4 is a flowchart showing a module C process according to the first exemplary embodiment.

FIG. 5 shows a schematic of a transmission command from the PC according to the first exemplary embodiment.

FIG. 6 shows a schematic of a status transmitted from the PC according to the first exemplary embodiment.

FIG. 7 shows a schematic of disc information transmitted from the PC according to the first exemplary embodiment.

FIG. 8 shows a schematic of disc information transmitted from the PC according to the first exemplary embodiment.

FIG. 9 is a flowchart showing a module A process according to the first exemplary embodiment.

FIG. 10 is a flowchart showing a command transmission process according to the first exemplary embodiment.

FIG. 11 is a flowchart showing a module B process according to the first exemplary embodiment.

FIG. 12 shows a schematic of a status transmitted from the video camera according to the first exemplary embodiment.

FIG. 13 shows a schematic of a state of a module A and a module B according to the first exemplary embodiment.

FIG. 14 is a flowchart showing a process of the video camera according to the first exemplary embodiment.

FIG. 15 shows a schematic of an example of a display screen in performing dubbing.

FIG. 16 is a flowchart showing a process of the video camera according to the first exemplary embodiment.

FIGS. 17A to 17G show schematics of examples of a display screen in performing dubbing.

FIG. 18 shows a schematic of a state of response data from the video camera according to the first exemplary embodiment.

FIG. 19 is a flowchart showing a process of the video camera according to the first exemplary embodiment.

FIGS. 20A to 20C show schematics of examples of a display screen in performing dubbing.

FIG. 21 is a flowchart showing a process of the video camera according to the first exemplary embodiment.

FIG. 22 is a flowchart showing a process of a format instruction by the video camera according to the first exemplary embodiment.

FIG. 23 is a flowchart showing a process of the video camera according to the first exemplary embodiment.

FIGS. 24A to 24G show schematics of examples of a display screen in performing dubbing.

FIG. 25 is a flowchart showing a process of the video camera according to the first exemplary embodiment.

FIG. 26 shows a schematic of a recording/reproduction system configuration to which at least one exemplary embodiment is applied.

FIG. 27 shows a schematic of a structure of a PC according to a second exemplary embodiment of the present invention.

FIG. 28 is a flowchart showing a module D process according to the second exemplary embodiment.

FIG. 29 shows a schematic of a transmission command from the PC according to the second exemplary embodiment.

FIG. 30 shows a schematic of response data from the video camera according to the second exemplary embodiment.

FIG. 31 shows a schematic of response data from the video camera according to the second exemplary embodiment.

FIG. 32 shows a schematic of response data from the video camera according to the second exemplary embodiment.

FIG. 33 shows a schematic of a status transmitted from the PC according to the second exemplary embodiment.

FIG. 34 is a flowchart showing a module C process according to the second exemplary embodiment.

FIG. 35 shows a schematic of a transmission command from the PC according to the second exemplary embodiment.

FIG. 36 shows a schematic of a transmission command from the PC according to the second exemplary embodiment.

FIG. 37 shows a schematic of a disc information transmitted from the PC according to the second exemplary embodiment.

FIG. 38 is a flowchart showing a module A process according to the second exemplary embodiment.

FIG. 39 is a flowchart showing a process of the video camera according to the second exemplary embodiment.

FIG. 40 shows a schematic of an example of a display screen in performing dubbing according to the second exemplary embodiment.

FIG. 41 is a flowchart showing a display process of a recording/reproduction drive according to the second exemplary embodiment.

FIG. 42 is a flowchart showing a process of a format instruction by the video camera according to the second exemplary embodiment.

FIG. 43 shows a schematic of an example of a display screen in performing dubbing according to the second exemplary embodiment.

FIG. 44 shows a schematic of a warning screen in performing dubbing according to the second exemplary embodiment.

FIG. 45 is a flowchart showing a process of the video camera according to the second exemplary embodiment.

### DESCRIPTION OF THE EMBODIMENTS

The following description of at least one exemplary embodiment is merely illustrative in nature and is in no way intended to limit the invention, its application, or uses.

Processes, techniques, apparatus, and materials as known by one of ordinary skill in the relevant art may not be discussed in detail but are intended to be part of the enabling description where appropriate, for example the particular visual display icons can vary with icon and meaning, additionally although an optical disc is referred to herein to store image data, and data storage device as known by one of ordinary skill in the relevant arts and equivalents can be used (e.g., RAM, hard drives), also video cameras are referred to in examples however and type of imaging apparatus can be used (e.g., digital cameras).

In all of the examples illustrated and discussed herein any specific values should be interpreted to be illustrative only and non limiting. Thus, other examples of the exemplary embodiments could have different values.

Notice that similar reference numerals and letters refer to similar items in the following figures, and thus once an item is defined in one figure, it may not be discussed for following figures.

Hereinafter, a detail description will be given of exemplary embodiments with reference to the accompanying drawings.

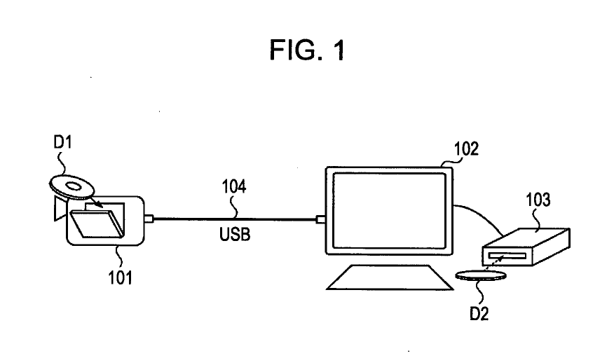

FIG. 1 shows a schematic of a data transfer system configuration example to which at least one exemplary embodiment is applied.

The system of FIG. 1 is structured by a video camera 101 for recording and reproducing picked-up image data on an optical disc D1 such as a DVD-RAM, which can have a diameter of 8 cm, and a PC 102 including a recording/reproduction drive 103 for recording and reproducing data with respect to an large capacity optical disc D2 such as a DVD-RAM, which can have a diameter of 5 cm.

The video camera 101 and the PC 102 respectively have USB interfaces. By connecting a USB cable 104 to there USB interfaces, data transmission is realized. In this exemplary embodiment, a mass storage transfer can use a USB transmission protocol. Also in this exemplary embodiment, the data recorded on the optical disc D1 is transferred to the PC 102, whereby recording can be performed on the large capacity optical disc D2.

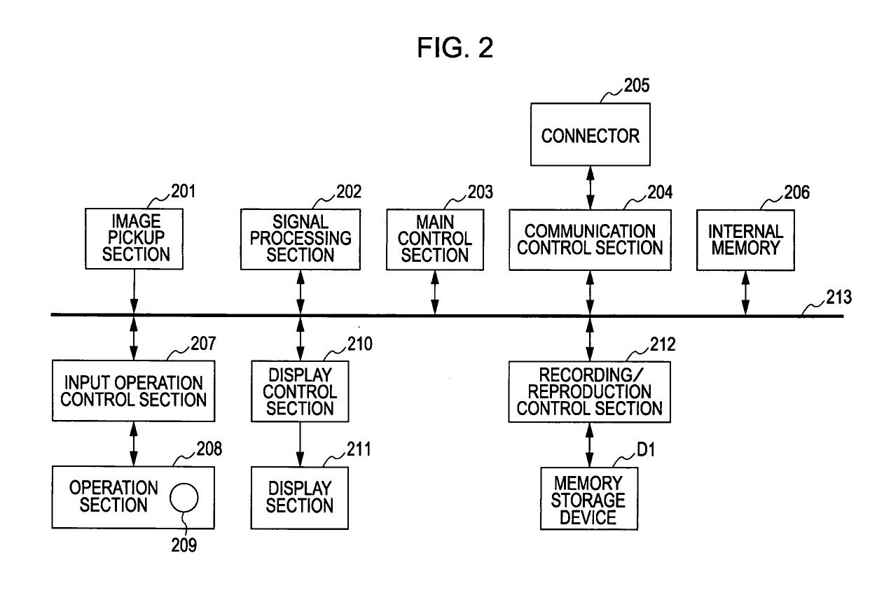

FIG. 2 is a block diagram showing a main structure of the video camera 101.

An image pickup section 201 generates moving image data by filming a subject to be output to a bus 213. A signal processing section 202 encodes the moving image data output from the image pickup section 201 with a known encoding method at the time of recording to be output to a recording/reproduction control section 212. At the time of reproduction, the moving image data reproduced from the disc D1 is decoded to be output to a display control section 210. A main control section 203 is connected to components via the bus 213 for controlling the components with software that is operating on the main control section 203. A communication control section 204 performs communication control in accordance with a mass storage standard in the case where the communication control section 204 is connected to an external device, that is, the PC 102 of FIG. 1, via a device connector 205 (e.g., USB connector) with the cable 104 (e.g., USB cable). Reference numeral 206 denotes an internal memory where various types of software used in the main control section 203 and various information transmitted from the PC 102 can be stored.

An input operation control section 207 determines key information generated when a user performs the input to an operation section 208 and notifies the software operating on the main control section 203 of the key information. Also, the operation section 208 includes a button 209 in which an LED is embedded that can be turned on and off. The button 209 has a function of instructing the user to start dubbing when the video camera 101 is connected to the PC 102 with the USB cable 104. Also, the button 209 has a function of notifying the user as to whether the dubbing with the PC 102 can be performed on the basis of the lighting status of the lighting status of the LED.

The display control section 210 generates images to be displayed on a display section 211 to control the display. For the memory storage device (e.g., optical disc) D1, the recording/reproduction control section 212 controls the recording and reproduction of the picked-up data and transfer of the read data to the internal memory 206. The read data is transmitted to the outside via the communication control section 204 or transferred to the display section via the display control section 210.

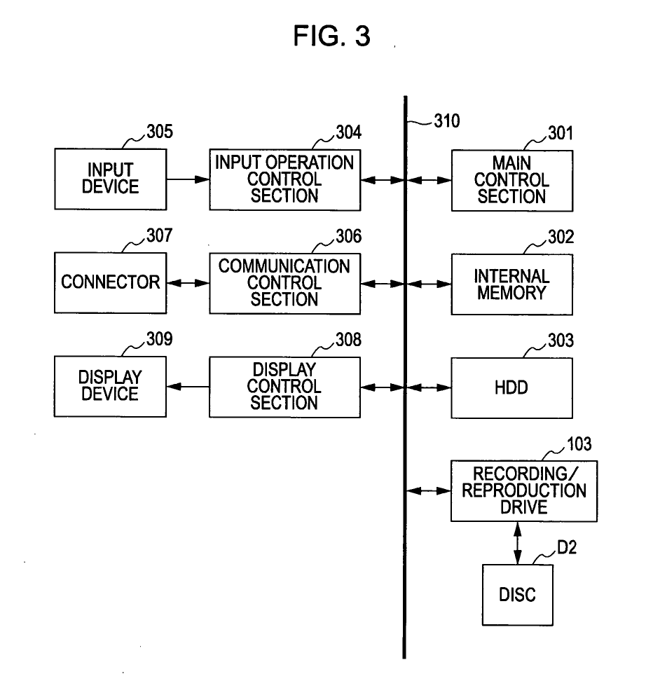

FIG. 3 is a block structural diagram showing a mail part of the PC 102.

As illustrated in the drawing, PC 102 includes a main control section (which includes a CPU) 301 for mastering the entire device control, an internal memory 302 that can be used for loading an operation system (OS) and various applications and used as a buffer area when data is written on the optical disc D2, hard drive disc (HDD) 303 storing the OS and various application programs including an application for controlling the recording/reproduction drive 103 used in this exemplary embodiment, an input operation control section 304 configured to output the input from an input device 305 which includes a pointing device such as a mouse and a key board to the main control section 301, a communication control section 306 configured to perform transmission and reception of the data via a USB host connector 307, a display control section 308 configured to output video signals to a display section 309 which includes a CRT, a liquid crystal display, or other related or equivalent image display apparatus and/or methods as known by one of ordinary skill in the relevant art and drawing the data in an internal video memory in response to a request from the main control section 301, and a data bus 310 configured to perform transmission and reception of the data between the respective function blocks.

In the above, the structures of the video camera 101 and PC 102 according to this exemplary embodiment have been described. Next, a process according to this exemplary embodiment will be described. Description for an application program in the PC 102

The application program stored in the HDD 303 according to this exemplary embodiment is roughly includes the following three program modules A to C. The respective programs achieve the following functions.

The module A: a program for performing status communication between the video camera and the PC.

The module B: a program for performing reception of the image data transmitted from the video camera and a writing process (dubbing process) on the optical disc D2.

The module C: a program to be resident in the internal memory 206 when the “OS” is activated, is configured to detect whether or not a supported video camera is connected.

In this exemplary embodiment, with these three modules, the video camera 101 and the PC 102 are connected to each other with the USB cable 104. Thus, a function of determining whether or not the writable optical disc D2 is mounted to the recording/reproduction drive 103 and a dubbing function of automatically transmitting to the PC 102 μl the data files stored on the optical disc D1 that is mounted to the video camera 101 and writing the data on the optical disc D2.

The internal memory 302 can be used for not only the application program according to this exemplary embodiment but also various application programs (for example, document editing and mailing, WWW browser, and other related or equivalent application programs as known by one of ordinary skill in the relevant art) to be used by the user.

Therefore, when the video camera 101 is not connected to the PC 102, it can be useful that the area used by the applications of this exemplary embodiment in the internal memory 302 is small. For this reason, the program resident in the internal memory 302 is not for all the application programs and can be for the module C that decides whether or not the application is activated.

It should be noted that in at least one exemplary embodiment, the device name of the video camera is known. The USB interface is an interface originally designed as Hot Plug and Play. When the video camera 101 is connected to the USB host connector 307 via the USB cable 104, the mass storage communication is established. This communication establishment procedure can be via a conventional method.

At this time, in at least one exemplary embodiment, the OS recognizes the connected device and obtains the device name. The module C according to this exemplary embodiment monitors the event generation in which a device is connected to the USB host connector 307 and executes the process at the time of the USB device connection. Hereinafter, processes of the respective modules A to C will be described. Description for the module C (resident program)

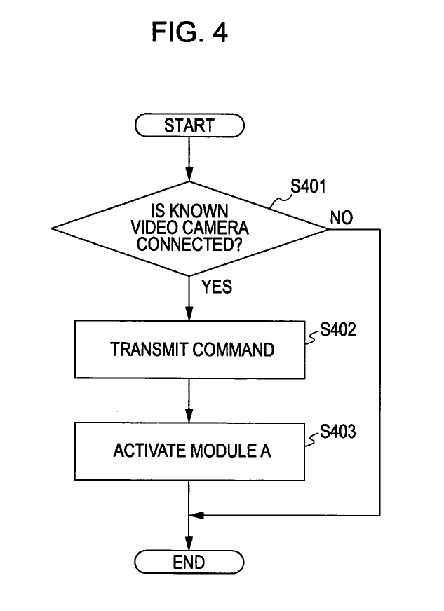

FIG. 4 is a flowchart showing the process steps of the module C according to this exemplary embodiment. This process is executed when any device is connected to the USB host connector 307 as described above.

First of all, in Step S401, it is determined whether or not the connected USB device is a known video camera 101. When the device is an unknown video camera, this process ends or a default setting is used (e.g., closest matching video camera in memory). When it is determined that the known video camera 101 is connected, the process proceeds to Step S402. When the PC 102 can perform dubbing, a command “READY (0)” that will be described later is transmitted to the video camera 101 via the USB host connector 307.

Also, in Step S402, when the dubbing cannot be performed and the status is BUSY, a command “BUSY (6)” that will be described later is transmitted. When the recording/reproduction drive 103 is not connected to the PC 102, a command “NO DRIVE (7)” that will be described later is transmitted. When the PC 102 is not supplied with a sufficient electric power, a command “LOW BATTERY (8)” that will be described later is transmitted. Next, in Step S403, the program module A is activated (e.g., the program module A is read from the HDD 303 into the internal memory 302 for execution).

It should be noted that the process of FIG. 4 is executed when a new USB device is connected to the USB host connector 307. When the recording/reproduction drive 103 is connected to the USB host connector 307, the process of FIG. 4 is executed similarly.

In this case, Step S401 is NO, the process ends as it is or a default is used. In addition to this case, for example, if the PC 102 accommodates the recording/reproduction drive 103, the process of FIG. 4 can be executed when the optical disc D2 is mounted to the recording/reproduction drive 103.

Description for the Module A

Module A is a module executed, as described above, when the video camera 101 and the PC 102 are connected to each other.

Furthermore, when the module A is activated, before that moment, some kind of command has been already transmitted to the video camera 101. Also, once the module A is activated, the module A resides in the internal memory 302 during a dubbing operation to be described later. The module A is executed when response data from the video camera 101 is received as well.

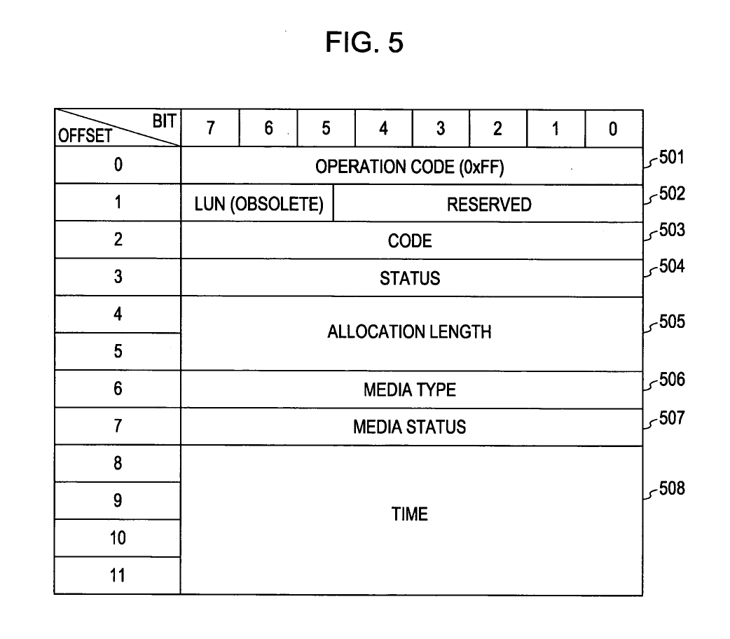

In the process of the module A, a command transmitted to the video camera 101 has a data structure shown in FIG. 5. The command of FIG. 5 includes 12 byte data based on the construction of ATAPI command block. In the ATAPI standard, a field 501 at the data offset 0 byte shows control information of this command block. However, the function of this exemplary embodiment is not defined under the ATAPI standard, so 0×FF indicating a vendor unique command (Ox represents a hexadecimal number) specifies the command information.

A field 502 has a structure for specifying a Logical Unit Number (LUN) in upper 3 bits on the basis of the ATAPI standard, but in this exemplary embodiment, 0 is specified. A field 503 can store data for specifying a detail function of this command. In this exemplary embodiment, 0×01 can be set in the field 503.

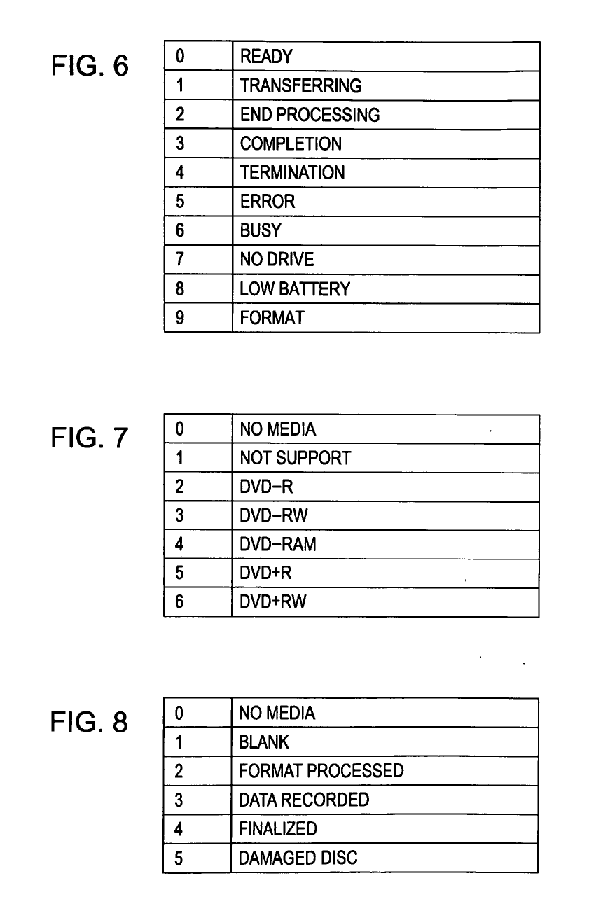

A field 504 is a field indicating status information of the PC 102, and a value shown in FIG. 6 can be set therein. The meaning of each value is as follows.

“READY (0)” indicates that the PC 102 can receive data and recording and storage thereof can be performed. “TRANSFERRING (1)” indicates that the data is being received. “END PROCESSING (2)” indicates that the data has been received to be recorded on the disc D2 and an end process is being executed. “COMPLETION (3)” indicates that the data has been received and recording on the disc D2 is completed. “TERMINATION (4)” indicates that the process is interrupted before the data has been received for the data recording and storage. “ERROR (5)” indicates that an error occurs in the process before the data has been received for the data recording and storage, for example, indicating the process interruption due to occurrence of a writing error. “BUSY (6)” indicates that the PC 102 executes another process and the dubbing cannot be performed. “NO DRIVE (7)” indicates that the recording/reproduction drive 103 is not connected to the PC 102. “LOW BATTERY (8)” indicates that the electric power is not sufficient for battery drive, for example, the PC 102 is of a portable type. “FORMAT (9)” indicates that the PC 102 is in a format process.

A field 505 represents a data length of the data acquired from the video camera 101 in the PC 102.

A field 506 represents a type of the optical disc mounted to the recording/reproduction drive 103 that is connected to the PC 102 and a value shown in FIG. 7 can be set therein. The meaning of each value is as follows.

“NO MEDIA (0)” indicates that the optical disc D2 is not mounted to the recording/reproduction drive 103 that is connected to the PC 102. “NOT SUPPORT (1)” indicates that the optical disc D2 mounted to the recording/reproduction drive 103 that is connected to the PC 102 is nonsupported media. “DVD-R (2)” indicates that the DVD-R optical disc D2 is mounted to the recording/reproduction drive 103 that is connected to the PC 102. “DVD-RW (3)” indicates that the DVD-RW optical disc D2 is mounted to the recording/reproduction drive 103 that is connected to the PC 102. “DVD-RAM (4)” indicates that the DVD-RAM optical disc D2 is mounted to the recording/reproduction drive 103 that is connected to the PC 102. “DVD+R (5)” the DVD+R optical disc D2 is mounted to the recording/reproduction drive 103 that is connected to the PC 102. “DVD+RW (6)” indicates that the DVD+RW optical disc D2 is mounted to the recording/reproduction drive 103 that is connected to the PC 102.

A field 507 represents a status of the optical disc mounted to the recording/reproduction drive 103 that is connected to the PC 102, and a value shown in FIG. 8 can be set therein. The meaning of each value is as follows.

“NO MEDIA (0)” indicates that any media are not mounted to the recording/reproduction drive 103. “BLANK (1)” indicates that media mounted to the recording/reproduction drive 103 are a blank disc (disc without any record). “FORMAT PROCESSED (2)” indicates that the media mounted to the recording/reproduction drive 103 are a formatted disc. “DATA RECORDED (3)” indicates that the media mounted to the recording/reproduction drive 103 have already some data recorded thereon. “FINALIZED (4)” indicates that the disc mounted to the recording/reproduction drive 103 has been finalized. “DAMAGED DISC (5)” indicates that the media mounted to the recording/reproduction drive 103 are a damaged disc (data cannot be written on the disc properly or data on the disc cannot be read out properly).

A field 508 can store, in the case of dubbing, as will be described below, data indicating the remaining time until the dubbing of data on the disc D1 is completed (writing completion) on the optical disc D2.

As described above, when the module A is activated, any one of the commands “READY (0)”, “BUSY (6)”, “NO DRIVE (7)”, and “LOW BATTERY (8)” has been already transmitted from the PC 102 to the video camera 101, the reply (response data) is returned from the video camera 101.

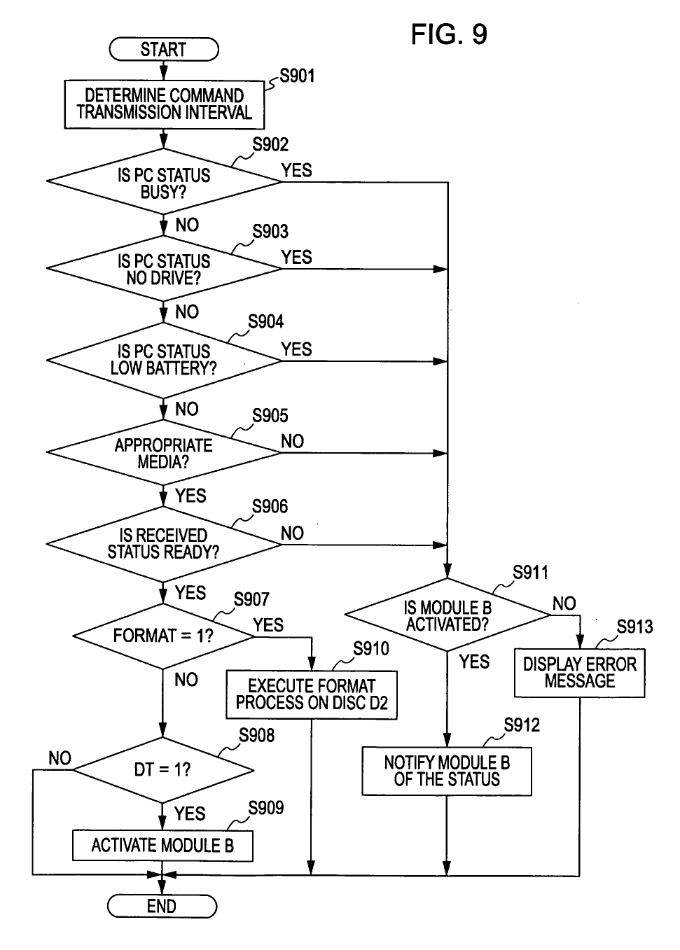

Then, as will be described later, during the dubbing as well, the response data is returned from the video camera 101. In that case too, a process in accordance with this response data is executed. In keeping with the above-mentioned point, the process of the module A will be described on the basis of a flowchart of FIG. 9.

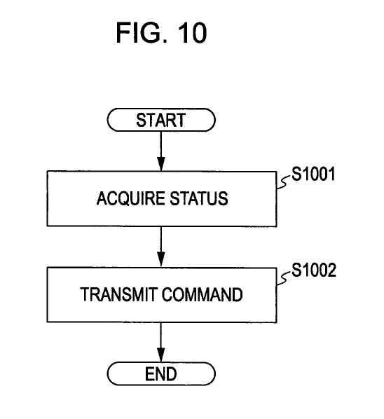

First of all, in Step S901, in accordance with a field value of the received response data, the transmission time for transmitting a command for the next time can be set. After the transmission time has been set, when the time reaches the transmission time, a command transmission process constructing the module A (FIG. 10) is executed.

As illustrated in FIG. 10, in this command transmission process, a status of the PC 102 is acquired in Step S1001. Then, in Step S1002, the acquired status is transmitted to the video camera 101 as a command of data structures as shown in FIG. 5. Thus, as the response data is returned from the video camera 101, this process can be executed each time.

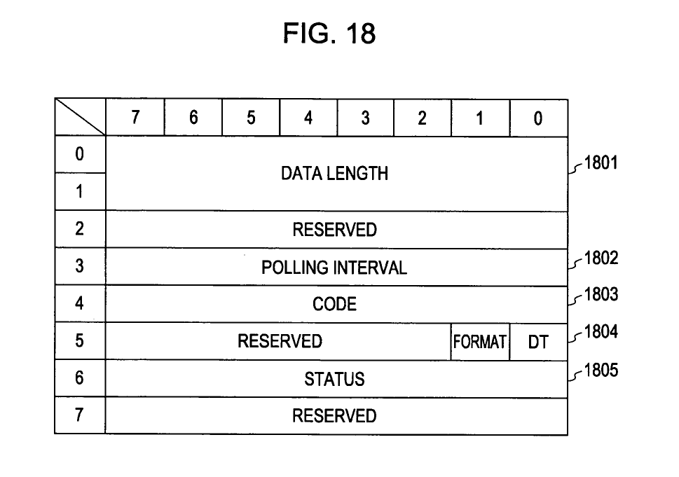

Now, FIG. 9 will be described again. After the process of Step S901, that is, the setting of the activation timing for the command transmission is performed, the process proceeds to Step S902 to check the status of the PC 102. When the status is not BUSY, the process proceeds to Step S903 to check whether or not any drive is present. When a drive is present, the process proceeds to Step S904 to check whether or not the battery is in a low battery status (LOW BATTERY). When the battery is not in the low battery status, the process proceeds to Step S905 to check whether or not a writable drive is inserted in the recording/reproduction drive 103. Then, the drive information is stored in the media type field (the field 506 of FIG. 5). When the media type is writable media, the process proceeds to Step S906 to check a response data field (a field 1805 of FIG. 18 described below). When the response data field is “READY (0)”, it is determined that the video camera 101 can transmit the data of the picked-up image, and the process transits to Step S907.

In Step S907, a format bit of a response data field 1804 shown in FIG. 18 is checked to determine whether or not 1 is set therein. As the detail will be described later, when a request for executing a format process on the recording destination disc D2 is generated from the video camera 101, 1 is set in this field. When the format bit is set to 1, the process proceeds to Step S910 to execute the reset process on the disc D2 mounted to the recording/reproduction drive 103.

Whereas, in Step S907, when the format bit is not set to 1, the process proceeds to Step S908 to check whether or not a DT bit of the response data field 1804 shown in FIG. 18 is set to 1. The detail will be described later, however when a button for instructing the dubbing start in the video camera 101 is manipulated, 1 is set in this field. When the DT bit is set to 1, the process transits to Step S909 to activate the module B in which reading of the data recorded on the optical disc D1 and writing of the data to the large capacity optical disc D2 (dubbing) are performed (the module is loaded from the HDD 303 to the internal memory 302 for execution), and the process ends.

On the other hand, when it is determined that the PC 102 is BUSY in Step S902, the recording/reproduction drive 103 is absent in Step S903, the battery is in the low battery status in Step S904, an appropriate medium is not inserted in Step S905, or the status of the response data field 1805 is other than “READY (0)” in Step S906, the process proceeds to Step S911. Then, it is determined whether or not the module B is activated. When the module B is activated, in Step S912, the module B is notified of the status to finish the process.

In Step S911, when the module B is not activated, the process transits to Step S913 to display an error message on the display section 309 and display a process. Then, the process ends.

It should be noted that although the description is out of sequence, the OS operating on the PC 102 is a multitask OS and the modules A and B individually operate as a separate task.

Description for the Module B

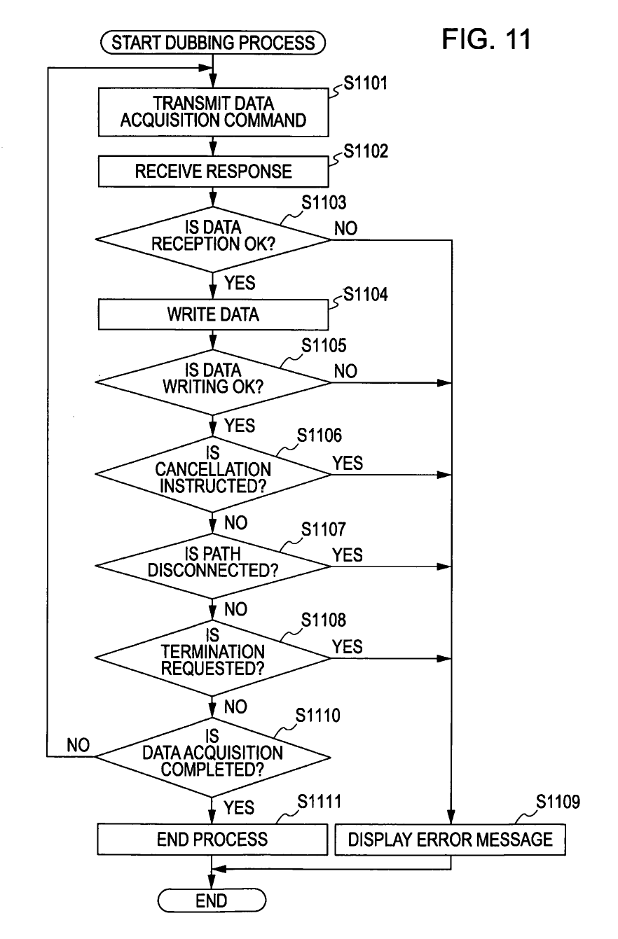

Next, a process of the module B will be described in accordance with a flowchart of FIG. 11.

In Step S1101, a data acquisition command is transmitted to the video camera 101. Here, the data acquisition command is generated in accordance with the ATAPI standard and transmitted with a communication method based on a USB mass storage class. Note that this is a non-limiting example only of at least one exemplary embodiment. The discussion herein of the ATAPI standard is illustrative, other standards or custom made standards can be utilized in exemplary embodiments.

In Step S1102, a response from the video camera 101 is received. In Step S1103, it is determined whether or not the received data is an error. When the received data is an error, the process transits to Step S1109 to display an error message on the display section 309 and the process is finished. When the received data is not an error, the process transits to Step S1104.

In Step S1104, the data that should be subjected to the dubbing is received. Writing of the received data is instructed to the recording/reproduction drive 103 and writing on the disc D2 can be performed. In Step S1105, when a writing error occurs and the writing error occurrence is detected, the process transits to Step S1109 to display an error message on the display section 309 and the process is finished. When there is no error occurrence, the process transits to Step S1106.

In Step S1106, it is determined whether or not the instruction of cancellation of the writing is input from the input device 305 by the user, when the instruction of cancellation of the writing is input, the process transits to Step S1109 to display an error message on the display section 309 and the process is finished.

It should be noted that according to this exemplary embodiment, the dubbing process is apparently executed as the background process of the PC 102. However, when the module B is activated, the icon is displayed on a task bar provided to the OS. When the icon is specified, a menu is displayed and cancellation of the dubbing can be instructed from the menu.

In Step S1106, when the cancellation is not instructed, the process transits to Step S1107 to check whether or not the USB connection between the video camera 101 and the PC 102 is achieved in the communication control section 306. When it is detected that the connection is not achieved, the process transits to Step S1109 to display an error message on the display section 309 and the process is finished. When the USB connection is achieved, the process transits to Step S1108.

In Step S1108, it is checked whether or not a termination request is issued from the software module A. When the termination request is issued, the process transits to Step S1109 to display an error message on the display section 309 and the process is finished.

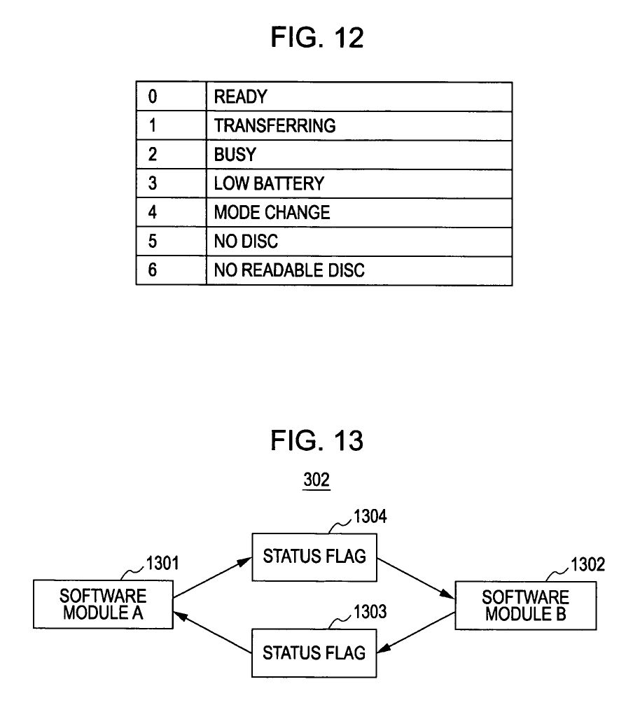

In this exemplary embodiment, on the basis of the status flag secured on the internal memory 302, notification from the software module A to the software module B can be performed. Values the status flag can take in this case are shown in FIG. 12. FIG. 12 illustrates the status of the video camera 101 as will be described below. When “LOW BATTERY” (3), “MODE CHANGE” (4), “NO DISC” (5), or “NO READABLE DISC” (6) is set, the termination request is issued. Similarly, in accordance with the values of FIG. 6, when “BUSY”, “NO DRIVE”, or “LOW BATTERY” is set, the termination request is issued. When there is no termination request, the process transits to Step S1110.

Here, when the termination request is issued on the basis of “LOW BATTERY” (3), in Step S1109, it is possible to display a message for instructing the connection of a household electric power supply (AC adaptor) to the video camera 101.

Thus, even when the remaining battery of the video camera 101 becomes low during the dubbing, the user can connect the AC adaptor to the video camera 101. For this reason, the interruption of the dubbing process can be avoided.

In Step S1110, it is determined that the reception of all the data recorded on the optical disc D1 is completed. As the recording capacity can be identified in the mass storage communication, the information is utilized here. When all the data is not acquired, the process transits to Step S1101 again to continue the process.

On the other hand, in Step S1110, when it is determined that acquisition of all the data is completed, the process proceeds, to Step S1111 and the module B and the module A are finished (the OS is notified of the end of the modules A and B and those programs are released from the internal memory 302).

It should be noted that the software module B performs notification to the software module A according to the module B status during the execution of the flow of FIG. 11. Similarly to the above, with the status flag placed on the internal memory 302, the notification can be performed from the software module B to the software module A. At this time, the considerable values follow the values of FIG. 12. Thus, the process shown in FIG. 10 is executed also during the dubbing.

FIG. 13 shows a schematic of a status when the software module A and the software module B perform the notification via the status flag placed on the internal memory 302.

The notification from the software module A 1301 to the software module B 1302 can be performed via the status flag 1304 secured within the internal memory 302. On the other hand, the notification from the software module B 1302 to the software module A 1301 can be performed via a status flag 1303.

A timing for performing the notification from the software module B to the software module is as follows with reference to the flowchart of FIG. 11.

Step S1101: “TRANSFERRING” (1) is notified.

Step S1109: When the transition from Step S1103 or Step S1105 is performed, “ERROR” (5) is notified, and when the transition is performed from Step S1106, “TERMINATION” (5) is notified.

Therefore, the processes in Step S1001 of FIG. 10 can acquire the status from the status flag 1303 and transmits the status to the video camera 101.

Up to this point, the processes of the application programs in the PC 102 according to this exemplary embodiment (the module A, B, and C) have been described. Description for the process of the video camera 101

Next, the process of the video camera 101 according to this exemplary embodiment will be described.

The video camera 101 according to this exemplary embodiment can function as a mass storage class device when connected to the PC 102. Then, the application program operated by the PC 102 can use a mass storage class protocol to control the video camera 101 and all the data recorded on the disc D1 mounted to the video camera 101 is reproduced and taken in and recorded on the optical disc D2.

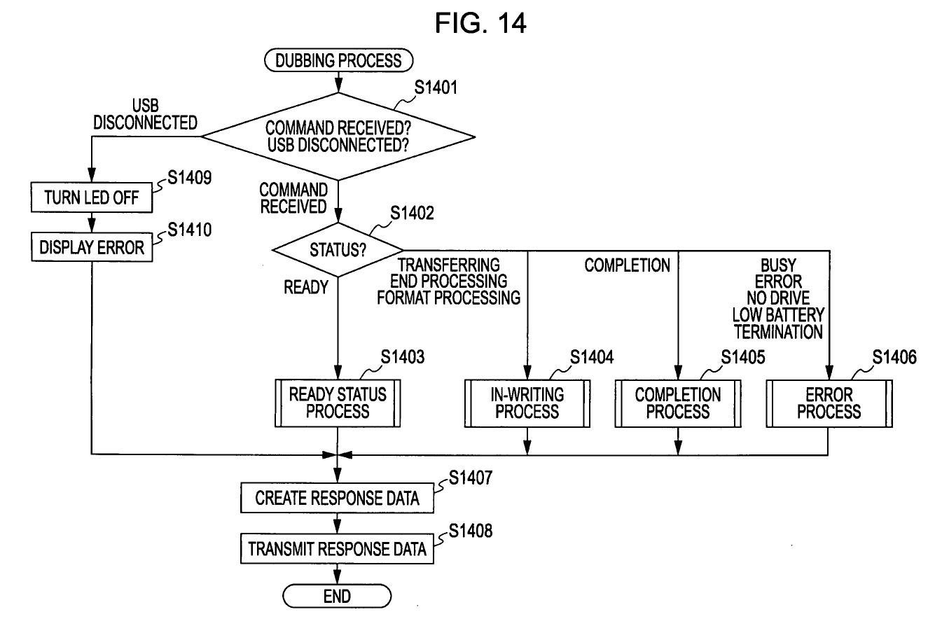

With reference to a flowchart of FIG. 14, a description will be given of a process to be executed by the main control section 203 according to the notification from the communication control section 204 in the condition where the video camera 101 is connected in the above-mentioned manner to the PC 102 via the USB cable 104 to establish the connection.

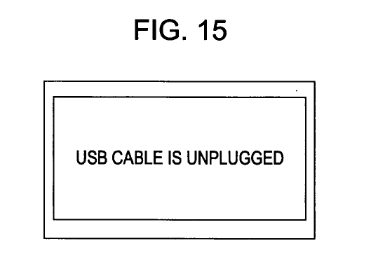

In Step S1401, it is determined that the main control section 203 has received a command from the PC 102 via the communication control section 204 or the USB cable is disconnected (if the USB cable is pulled out from the connector). When it is determined that the USB cable is disconnected, the process proceeds to Step S1409 to turn an LED of the button 209 off. Furthermore, the process proceeds to Step S1410 to display the disconnection of the USB cable on the display section 211 via the display control section 210. FIG. 15 shows a display example of the display section 211 in S1410. Steps S1407 and S1408 of the subsequent steps will be described later.

When the command has been received in Step S1401, the main control section 203 discriminates the command. Here, when the command is discriminated as the command encapsulated in the bit structure illustrated by FIG. 5, the process transits to Step S1402. However, when the command is another command, a process corresponding to the command is executed, but herein, for simplicity of the description, command processes other than commands encapsulated in the bit structure illustrated in FIG. 5 are omitted.

In Step S1402, when a value of the status field 504 of FIG. 5 is READY (0), which indicates that the PC 102 can record the received data, the process proceeds to Step S1403. In the case of “TRANSFERRING (1)”, “END PROCESSING”, or “FORMAT”, the process proceeds to Step S1404. In the case of “COMPLETION”, the process proceeds to Step S1405. Alternatively, in the case of “BUSY”, “ERROR”, “NO DRIVE”, “LOW BATTERY”, or “TERMINATION”, the process proceeds to Step S1406. Processes in the respective steps will be described in detail.

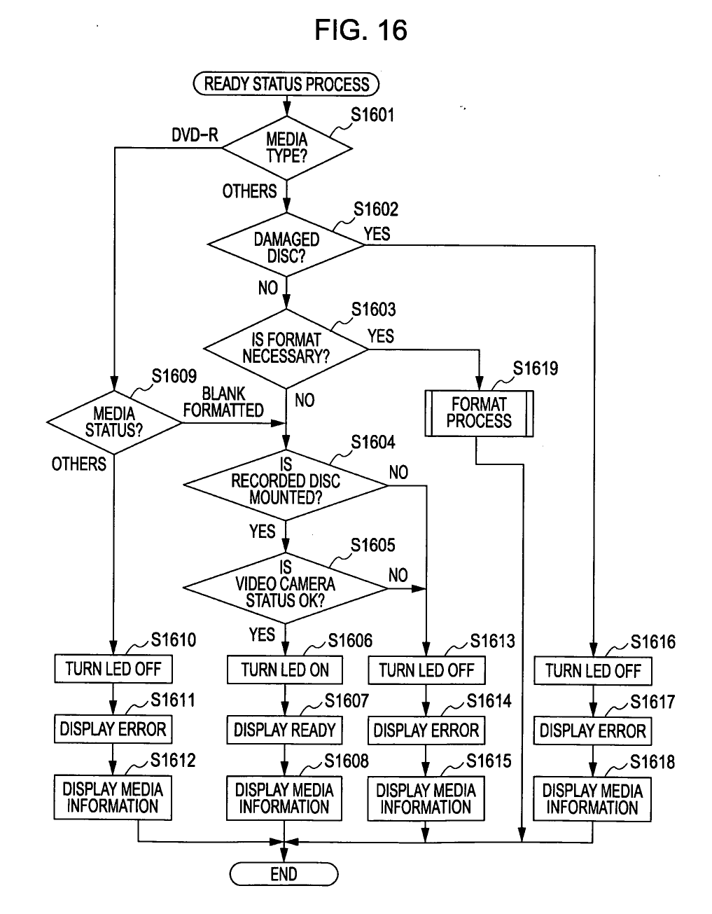

First of all, with reference to FIG. 16, a description will be given of the case where the READY (0) command is received, in other words, the case where the dubbing capable status of the PC 102 is notified.

In Step S1601, on the basis of a Media Type in the field 506 of FIG. 5, the type of the optical disc D2 mounted to the recording/reproduction drive 103 is identified. When the disc D2 is other than the DVD-R (2) in FIG. 7, the process transits to Step S1602. When the disc D2 is DVD-R (2), the case will be described later.

It should be noted that in this exemplary embodiment, the case of using the DVD as the optical disc has been described, but of course it is possible to use another disc medium or other storage medium. In that case, in S1601, it is discriminated that the disc D2 is a repeatedly rewritable disc like the DVD-RW or a write once (write once, read many) disc like the DVD-R.

In Step S1602, on the basis of the Media Status in the field 507 of FIG. 5, the status of the optical disc D2 mounted to the recording/reproduction drive 103 is discriminated. When the disc D2 status is other than “NO MEDIA” or “DAMAGED DISC” of FIG. 8, the disc can be determined as the writable disc and the process then transits to Step S1603. Here, the process in the case of “NO MEDIA” or “DAMAGED DISC” will be described later.

Next, in Step S1603, it is determined whether or not the recording destination disc D2 is a blank disc.

In this exemplary embodiment, to produce the duplication (copy) disc of the disc D1 that is mounted to the video camera 101, the following case is not desired where data has been already recorded on the recording destination disc D2. When the recording destination disc D2 is not a blank disc, that is, some kind of data has been recorded thereon, the format process on the disc D2 (complete deletion process) is executed to provide a blank disc. Then, the dubbing is executed on the blank disc.

Thus, in Step S1603, when the disc D2 is not a blank disc, the process proceeds to Step S1619 to execute a format process routine.

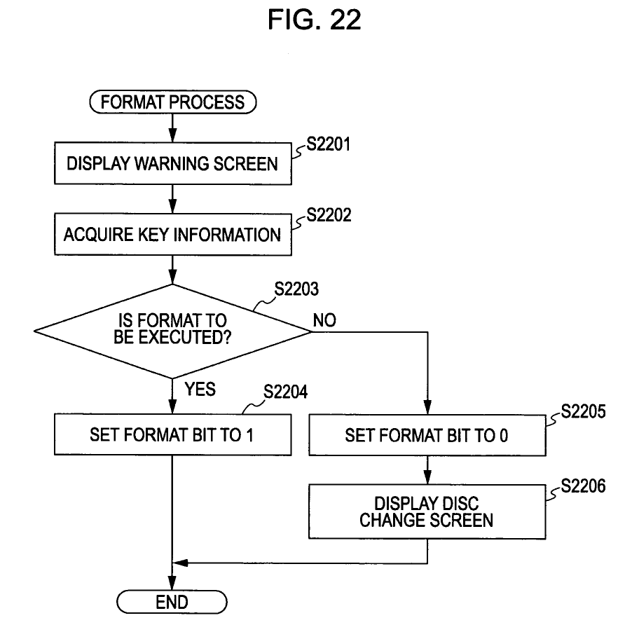

FIG. 22 is a flowchart showing the format process routine. It should be noted that the format process of FIG. 22 is instructed, in the PC 102, after all the data recorded on the disc D2 is deleted, the disc logical structure is established in accordance with the recording format of the image data.

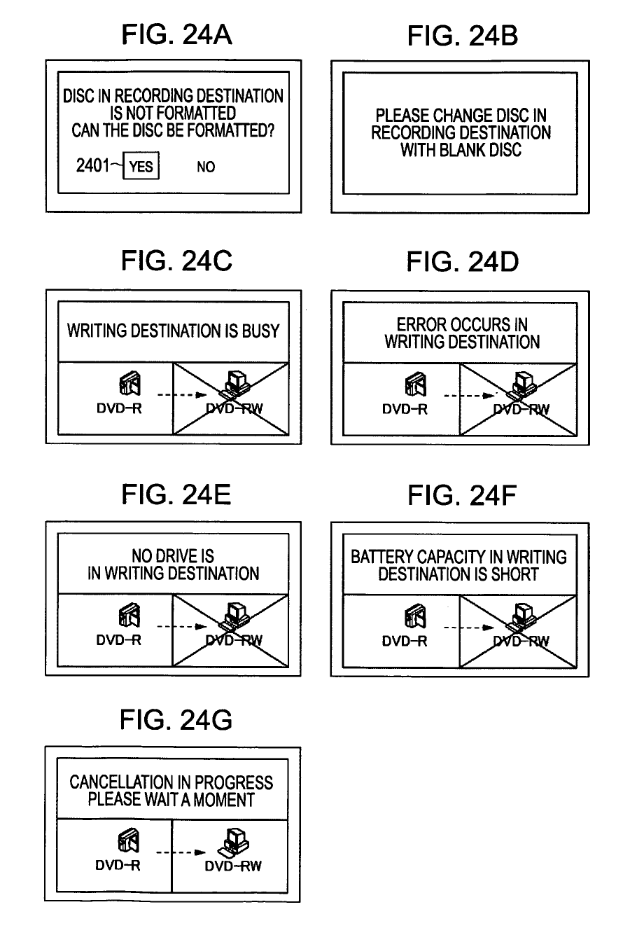

First of all, in Step S2201, a warning screen shown in FIG. 24A is displayed on the display section 211. When the user operates the operation section 208, a selection frame 2401 shown in FIG. 24B is moved to select whether or not format is executed. Then, in Step S2202, the selection result by the user is acquired to determine whether or not format is executed in Step S2203. When the format process is executed, in Step S2204, “READY” (0) is set in the field 1805 among the response data shown in FIG. 18 and a Format bit of a field 1804 is set to 1. Thus, with processes in Steps S1407 and S1408 to be described later, the response data having the format bit set to 1 is transmitted to the PC 102 and the reset operation is started in the PC 102, whereby the status is formatting. The response data of FIG. 18 will be described later.

On the other hand, in Step S2203, when NO is selected, in Step S2205, “READY” (0) is set in the field 1805 and contemporaneously the format bit of the field 1804 is set to 0. Then, in Step S2206, a screen for urging the disc change shown in FIG. 24G is displayed on the display section 211.

Now, FIG. 16 is described again. In Step S1603, when the disc mounted to the recording/reproduction drive 103 does not need the format process, the process proceeds to Step S1604. In Step S1604, it is determined whether or not the optical disc D1 is mounted to the video camera 101 and whether or not the image data can be recorded on the disc when the disc is mounted. When the disc is not mounted or the image data is not recorded on the disc although the disc is mounted, the process transits to Step S1613.

When the disc, which can have the image data recorded thereon, is mounted, in Step S1605, for example, it is determined whether or not the electric power source of the video camera 101 is in an appropriate status or in an appropriate mode to check whether or not the video camera 101 is in an appropriate status for the dubbing process.

For example, as a transfer band of the USB interface is 480 Mbps and sufficiently fast, when dubbing is performed from the optical disc D1 to the disc D2, the disc D1 is rotated at a higher speed as compared with the normal filming to read out the data. By transferring the data to the PC 102, the high speed dubbing can be performed. For this reason, when a mode of the video camera 101 is a filming mode where the disc D1 cannot be rotated at a high speed, the high speed dubbing cannot be performed on the PC 102. In S1605, in this manner, it is determined whether or not the video camera 101 is in an inappropriate mode for dubbing.

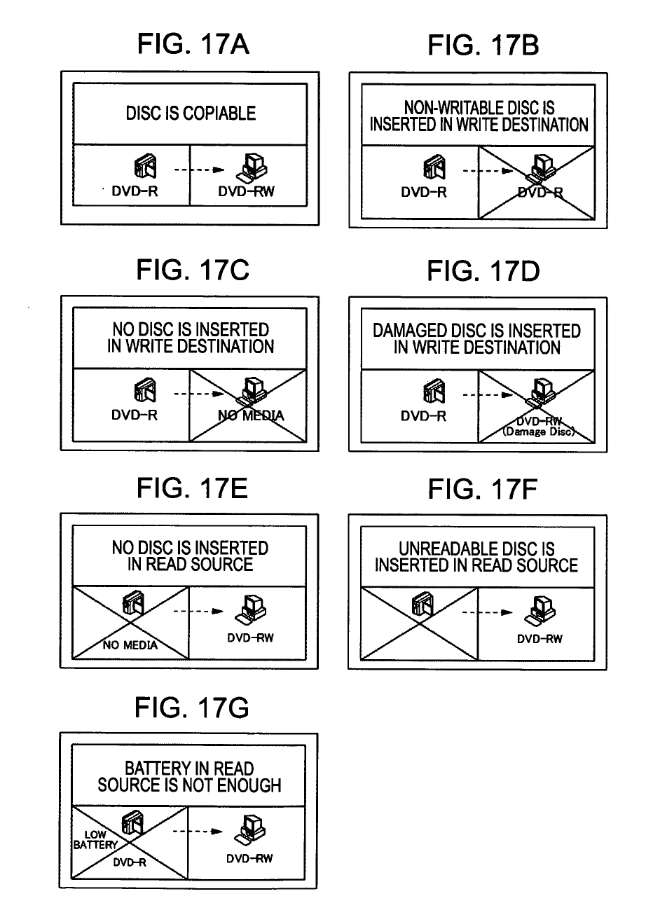

When the recorded optical disc D1 is inserted in the recording/reproduction control section 212 and it is determined that the status is not a low battery (LOW BATTERY) state and the mode is appropriate, the process proceeds to Step S1606, where the LED of the button 209 is turned on to inform the operator that the dubbing can be started. Then, the process proceeds to Step S1607 to display information indicating that writing can be currently performed via the display control section 210 on the display section 211. Moreover, the process proceeds to Step S1608 to display media information on the display section 211. FIG. 17A shows display examples of the display section 211 in Steps S1607 and S1608.

On the other hand, in Step S1601, when it is determined that the media of the optical disc D2 in the recording/reproduction drive 103 is DVD-R, the process transits to Step S1609. In Step S1609, the disc D2 status is detected as in Step S1602. Here, the disc D2 status is “BLANK” and “FORMATTED”, the process proceeds to Step S1604. Also, when the status of the media is other than “BLANK” or “FORMATTED”, the process transits to Step S1610.

In this exemplary embodiment, to produce the duplication (copy) of the disc D1 mounted to the video camera 101, the following case is not desired where data has been already recorded on the recording destination disc D2. The copy is prohibited unless the recording destination disc D2 is a blank disc and the disc is format processed according to the recording format.

In Step S1610, as the optical disc D2 mounted to the recording/reproduction drive 103 cannot accept the data writing, in order to notify the user of the status where the writing cannot be performed, the LED of the button 209 is turned off. Furthermore, the process proceeds to Step S1611 to notify that the optical disc D2 is a nonwritable disc with the display section 211 via the display control section 210. Then, in Step S1612, the media information at that time is displayed on the display section 211. FIG. 17B shows display examples of the display section 211 in Steps S1611 and S1612.

In Step S1602, when the status of the optical disc D2 inserted in the recording/reproduction drive 103 is “NO MEDIA” or “DAMAGED DISC” of FIG. 8, the disc is nonwritable, and the process transits to Step S1616.

In Step S1616, as the optical disc D2 mounted to the recording/reproduction drive 103 is a damaged disc or a disc is not mounted, to notify the user that the writing cannot be performed, the LED of the button 209 is turned off.

Then, the process proceeds to Step S1617, where the status where the optical disc D2 is a damaged disc or the optical disc D2 is not mounted is notified via the display control section 210 with the display section 211, and in Step S1618, the media information is displayed on the display section 211. FIGS. 17C and 17D show display examples in Steps S1617 and S1618. FIG. 17C illustrates the display example when no disc is inserted in the recording/reproduction drive 103 and FIG. 17D illustrates the display example when the mounted disc D2 is a damaged DVD-RW disc.

Also, in Steps S1604 and S1605, when the recorded optical disc D1 is mounted to the recording/reproduction control section 212, the recorded optical disc is readable media, and the status is a low battery (LOW BATTERY) status or the mode is inappropriate, the process transits to Step S1613.

In Step S1613, when the optical disc D1 is not inserted or the status is a low battery status or the mode is appropriate, to notify the user of the status where the data of the disc D1 cannot be transmitted to the PC, the LED of the button 209 is turned off.

Furthermore, the process proceeds to Step S1614, the status is notified with the display section 211 that the optical disc D1 is not inserted, the optical disc D1 is not a readable disc, the status is a low voltage status, or the mode is inappropriate. Then, in Step S1614, the media information at that time is displayed on the display section 211. FIG. 17E illustrates the display example at the case where no disc is inserted, FIG. 17F illustrates the display example at the case where an unreadable disc is inserted, and FIG. 17G illustrates the display example at the case where the status is a low voltage status.

When the process of the READY status is finished in the above-mentioned manner, the process transits to Step S1407 of FIG. 14. In Step S1407, the response data to the command from the PC 102 (FIG. 5) is generated. Here, the generated response data has an 8-byte structure shown in FIG. 18.

Hereinafter, the response data structure of FIG. 18 will be described.

A first two-byte field 1801 represents the response data length, and in this exemplary embodiment, 8-byte length can be set. A field 1802 specifies the time for the next command transmission by the PC 102 in about 100 ms unit. In other words, when the value of the field 1802 is set, for example, to 1, the PC 102 can be set to transmit the next command in about 100 ms.

Then, in this exemplary embodiment, as will be described below, when the user instructs the dubbing start, the value of the field 1802 can be set smaller than the value before the dubbing start. In other words, after the dubbing start, as compared with the time before the dubbing start, more frequently the command from the PC 102 is transmitted to the video camera 101. In this way, in the PC 102, the status change of the video camera 101 during the dubbing can be quickly recognized.

In addition, at the time during which the dubbing is not performed, as compared with the time during the dubbing, the transmission interval for the command from the PC 102 can be set longer, whereby the load on the PC 102 is relieved.

The value set in the field 503 by the command of FIG. 5 can be set in a field 1803 as it is. In this exemplary embodiment, 0×01 is specified.

The Format bit of the field 1804 is a flag indicating whether or not the format process of the disc D2 mounted to the recording/reproduction drive 103 is instructed by the user. When the format process is instructed, 1 is set therein.

A DT of the field 1804 is a flag indicating whether or not the user operates the dubbing instruction button 209 in the video camera 101. When the button 209 is operated, 1 is set therein. A detection process of the operation in the button 209 will be described later. The field 1805 represents the status of the video camera 101 and the value takes values shown in the table of FIG. 12. The meaning of each value is as follows.

“READY” (0) indicates that the video camera 101 can transmit data. “TRANSFERRING” (1) indicates that data is being transmitted. “BUSY” (2) indicates that the video camera 101 executes another process and it can be difficult to reply to the command request from the PC 102. “LOW BATTERY” (3) indicates that the battery voltage becomes low during data transmission. “MODE CHANGE” (4) indicates that the mode of the video camera 101 is changed. “NO DISC” (5) indicates that the disc D1 is not inserted in the video camera 101. “NO READABLE DISC” (6) indicates that the readable optical disc D1 is not inserted in the video camera 101.

Now, the flowchart of FIG. 14 is described again. A value according to the process result of FIG. 16 can be set in the field 1805 of the response data generated in Step S1407. For example, when the process transits from Step S1608, “READY” (0) indicating that the video camera 101 can transmit data is set. Also, at this time, when “1” is set in the DT of the field 1804, (when the user presses down the dubbing button 209), the response data according to the button operation is also generated. Also, the process transits from Step S1615, “LOW BATTERY” (3) or “NO DISC” (5) is set.

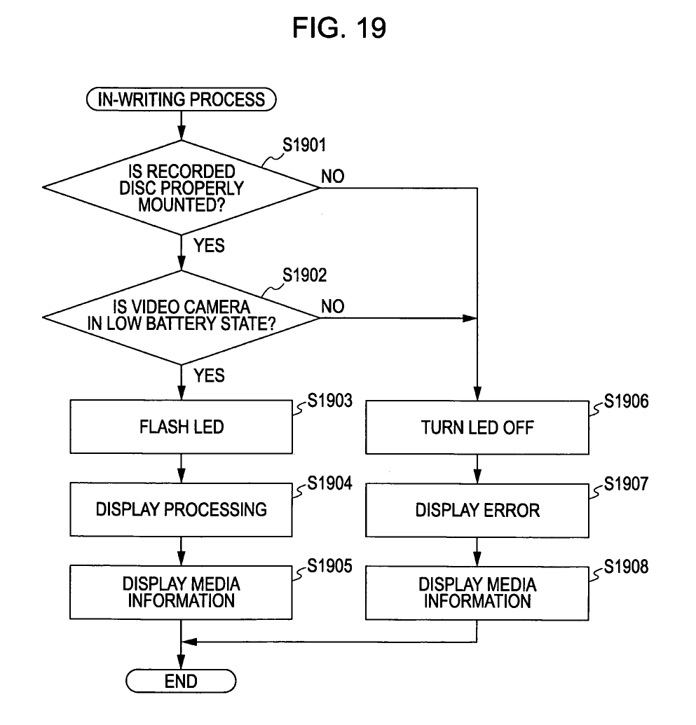

In Step S1402, when the status field 504 of the command from the PC 102 is “TRANSFERRING (1)”, “END PROCESSING (2)”, or “FORMAT (9)”, the process transits to S1404. A process in S1404 will be described with reference to the flowchart of FIG. 19.

First of all, in Step S1901, it is determined whether or not the optical disc D1 is properly mounted. When the optical disc D1 is not properly mounted, the process proceeds to Step S1906. On the other hand, when the optical disc D1 is properly mounted, it is determined whether or not the video camera 101 is not in the low battery state and the mode is appropriate. When the video camera is not in the low battery state and the mode is appropriate, the process transits to Step S1903 to turn the LED of the button 209 on, thereby informing the operator that the transferring process is executed.

Then, in Step S1904, when the writing process is executed, that effect is display on the display section 211 via the display control section 210. Also, when the status is “END PROCESSING” or during the format process, similarly, the situation where the process is being executed is displayed on the display section 211.

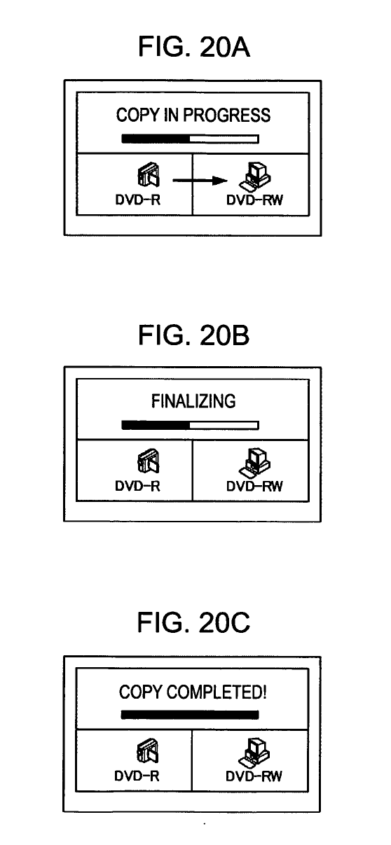

It should be noted that the writing remaining time information obtained from the time information in the field 508 is displayed contemporaneously. Also when the status is “END PROCESSING”, the end processing remaining time information obtained from the time information in the field 508 is displayed similarly. Then, in Step S1905, the media information is displayed on the display section 211. FIG. 20A shows an information display example during the writing and FIG. 20B shows an information display example during the end (finalizing) processing.

Also, in Step S1906, to notify the user that the writing cannot be performed, the LED of the button 209 is turned off. After that, the process proceeds to Step S1907 where it is notified whether the optical disc D1 is inserted, the optical disc D1 is not a readable disc, the status is a low voltage status, or the mode is inappropriate, via the display control section 210 with the display section 211. Then, in Step S1908, the media information at that time is displayed on the display section 211. FIG. 17E shows a display example in the case where no disc is inserted, FIG. 17F shows a display example in the case where an unreadable disc is inserted, and FIG. 17G shows a display example in the case where the status is a low voltage status.

After that, in Step S1407, the response data is generated. Similarly, “TRANSFERRING (1)” shown in FIG. 12 is set in the status field 505 at this time. Then, DT=1 is set the field 504 as the data is being transferred.

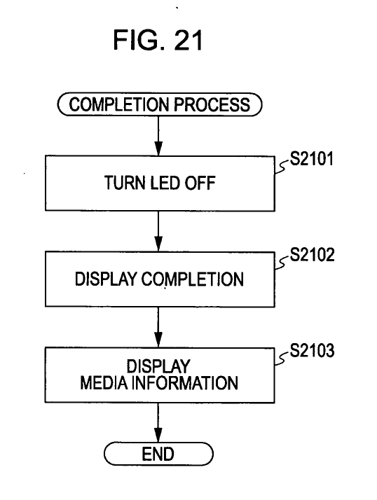

Then, in Step S1402, when the status field 504 of the received command is “COMPLETION (3)”, the process transits to Step S1405. A process in Step S1405 will be described with reference to a flowchart of FIG. 21.

When the data writing on the optical disc D2 inserted in the recording/reproduction drive 103 has been finished, in Step S2101, the user is notified that the disc copy has been finished by the LED of the button 209 being turned off. Furthermore, in Step S2102, the situation of the copy completion is displayed on the display section 211. Then, in Step S2103, the media information is displayed. FIG. 20C shows display examples in Steps S2102 and S2103.

After the completion of the process in S1405, in Step S1407, “READY (0)” is set in the field 1805 as the writing is finished. Then, 0 is set to the DT bit in the field 1804 as the data transfer is not performed.

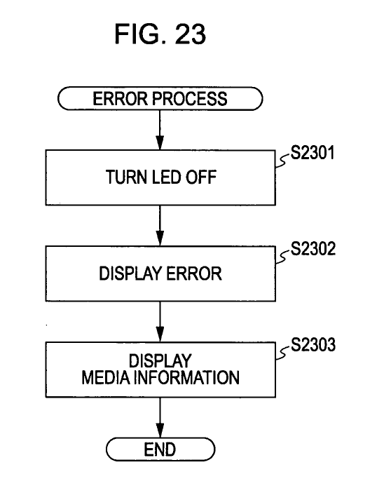

In Step S1402, when the status field 504 of the received command is “BUSY”, “ERROR”, “NO DRIVE”, “LOW BATTERY”, or “TERMINATION”, an error process in Step S1406 is executed. The error process will be described with reference to FIG. 23.

In Step S2301, when the PC 102 cannot execute the copy due to some error status as described above, to notify the user of the status where the disc copy cannot be performed, the LED of the button 209 is turned off. Then, in Step S2302, the error information is displayed on the display section 211 via the display control section 210, and in Step S2303, the media information is displayed. FIG. 24C shows a display example in the busy status. FIG. 24D shows a display example in the error status. FIG. 24E shows a display example in the no drive status. FIG. 24F shows a display example in the no battery status. Then, FIG. 24G shows a display example where cancellation is executed in the middle of the process.

After the error process in S1406, in Step S1407, “READY (0)” is set in the field 1805. Also, as the data transfer is not performed, 0 is set to the DT bit in the field 1804.

In the above-mentioned manner, in Step S1408, the generated response data is transmitted to the PC 102 via the communication control section 204 and the process is finished the process is finished.

It should be noted that when the response data is transmitted, the response data can be stored in the internal memory 206 until the next transmission is performed. In other words, the response data is generated by updating the previous response data.

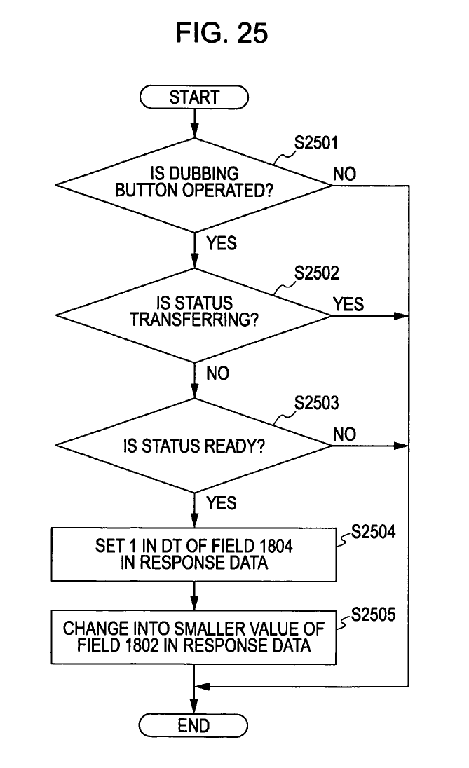

Next, a detection process for the user input in the video camera 101 will be described in accordance with a flowchart of FIG. 25. This process is asynchronously executed with respect to the process of FIG. 14. This process can be performed with software executed by the main control section 203 but if the response to the user is conducted at a high speed, this process can be realized by hardware interruption.

When any button of the operation section 208 is operated, this process is started.

First of all, in Step S2501, it is determined whether or not the operated button is the dubbing button 209. When the operated button is not the dubbing button, the process is finished.

When the dubbing button 209 is operated, the process proceeds to Step S2502 to check the status of the updated response data stored in the internal memory 206 and it is determined whether or not the status is “TRANSFERRING”. When the status is “TRANSFERRING”, the status means that the image data transfer has been already performed and this process is finished.

On the other hand, when it is determined the status is not “TRANSFERRING”, the process proceeds to Step S2503 and it is determined whether or not the response data status is READY. When the status is READY, the status means that the video camera 101 and the PC 102 wait for the dubbing instruction as the dubbing conditions are met. Then, the process proceeds to Step S2504 to set 1 in the DT of the response data field 1804 in the internal memory 206.

Then, in Step S2505, the value of the field 1802 is set smaller than before. To be specific, in the case where the value is set to about 100 ms before the dubbing instruction, after the dubbing instruction is caused, the value can be set to about half, for example, about 50 ms.

Thus, in the process of FIG. 14, when a command is received from the PC 102 next time, the response data with the DT of the field 1804 set to 1 is generated in Step S1407 of FIG. 14, whereby it is possible to notify that the dubbing instruction has been issued to the PC 102.

It should be noted that as described above, in this exemplary embodiment, the video camera 101 connected to the USB is processed as a mass storage. For this reason, the image data file acquisition process from the video camera 101 by the PC 102 can be performed as a separate task. From the viewpoint of the PC 102, the transmission of the mass storage class is the reading while the video camera 101 is regarded as an external memory device, which is related to the USB connected external memory device, and thus the description is omitted.

As has been described above, in this exemplary embodiment, when the data recorded on the disc D1 is reproduced by the video camera and transmitted to the PC and the data dubbing is performed on the disc D2, the information about the PC status related to this dubbing process is transmitted to the video camera and the PC status is displayed on the display section of the video camera. Thus, the user can instruct the dubbing by operating the video camera while the PC status displayed on the video camera is checked. Also, the video camera can function as the mass storage of the PC, as though the image file transfer to the PC can be performed under the control of the video camera.

It should be noted that in this exemplary embodiment, the case where the video camera is connected to the PC via the USB interface has been described. However, if the video camera can be recognized as the mass storage class device and the files can be read by using a mass storage device protocol, this exemplary embodiment can be applied to the case where the connection is established via IEEE1394 interface or a network interface.

Also, in this exemplary embodiment, the dubbing button 209 accommodates the LED but the LED may not be integrated with the button. However, in order to inform the user which button should be pressed down when the dubbing can be performed, the dubbing button and the LED can be integrated with each other.

It should be noted that according to this exemplary embodiment, in Step S1609 of FIG. 16, even when the disc is not a blank disc, in the case where the disc is not finalized, data can be still recorded on the disc.

That is, for the DVD-R disc, as the image data is recorded on the basis of the DVD format and the disc is subjected to the finalizing process, image recorded by a DVD video player can be reproduced. Also, when the finalizing process is performed on the DVD-R disc, the disc is made into a reproduction only disc and additional data cannot be written thereon. In other words, until the finalizing process is performed, as long as there is a free space, additional data can be written on the DVD-R disc.

For this reason, when the disc D2 of the copy destination is not a blank disc and not subjected to the finalizing process, data on the recording remaining amount of the copy destination disc is also transmitted to the video camera 101 from the PC 102 in addition to the disc information command of FIG. 8.

In the video camera 101, the data amount of the copy source disc D1 and the recording remaining amount of the copy destination disc D2 are compared with each other. As the result of the comparison, when the recording remaining amount of the copy destination disc is smaller, it is determined that copy cannot be performed and the process can be set to proceed to Step S1610. On the other hand, when the remaining recording amount of the copy destination disc is larger, the process is set to proceed to Step S1604.

By the setting the process in this way, even when the copy destination disc D2 is other than a blank disc, data of a plurality of discs D1 can be reduced to one disc D2.

Next, a second exemplary embodiment will be described.

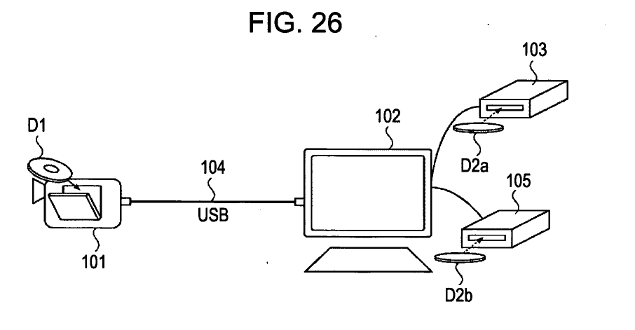

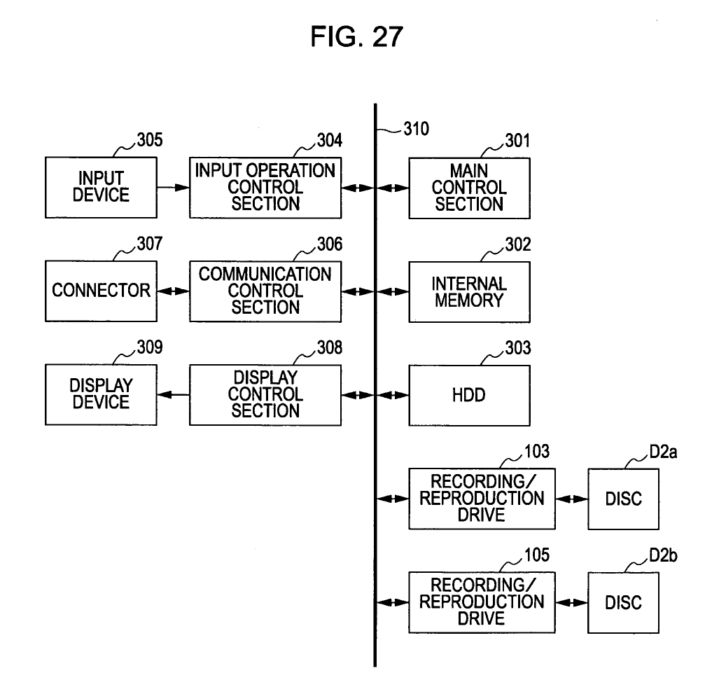

FIG. 26 shows a data transfer system configuration according to the second exemplary embodiment. The system of FIG. 26 includes, similarly to FIG. 1, the video camera 101 for recording and reproducing picked up image data on the optical disc D1 and the PC 102. In this exemplary embodiment, the PC 102 includes, in addition to the recording/reproduction drive 103 for recording and reproducing the data on the large capacity optical disc D2a, a recording/reproduction drive 105 for recording and reproducing the data on the large capacity optical disc D2b.

The video camera 101 and the PC 102 respectively include the USB interface and the data transmission is realized by connecting the USB cable 104 to there USB interfaces. In this exemplary embodiment, the case where a mass storage can be used for a USB transmission protocol will be described. Also in this exemplary embodiment, it is possible that the data recorded on the optical disc D1 is transferred to the PC 102 and recorded on the large capacity optical disc D2a or D2b.

In this exemplary embodiment, the structure of the video camera 101 is substantially the same as that shown in FIG. 2, but the process of transmitting the data on the disc D1 to the PC 102 is slightly changed and this point will be described later.

FIG. 27 shows a block structural diagram of the main part of the PC 102 according to this exemplary embodiment. In this exemplary embodiment as well, the structure of the PC 102 is substantially the same as that of FIG. 3, but the provision of the recording/reproduction drive 105 is different. The recording/reproduction drive 105 has the same structure and function as those of the recording/reproduction drive 103 and can record and reproduce the data on the mounted optical disc D2b. Next, processes according to this exemplary embodiment will be described.

Description for the Application Programs in the PC 102

According to this exemplary embodiment, the application program stored in the HDD 303 roughly includes the following four program modules A to D. The respective programs have functions described below.

The module A: a program for performing status communication between the video camera.

The module B: a program for performing reception of the picked-up image data from the video camera and a writing process (dubbing process) on the optical disc 1506.

The module C: a program to be resident in the internal memory 302 when the OS is activated, for detecting whether or not a supported video camera is connected.

The module D: a program for notifying the PC 102 of information about a plurality of connected recording/reproduction drives and selecting a dubbing destination amount the recording/reproduction drives.

In this exemplary embodiment, on the basis of these four modules, it is determined that the video camera 101 and the PC 102 are connected to each other via the USB cable 104 and the writable optical disc D2a or D2b is mounted to the recording/reproduction drives 103 and 105. Then, all the data files stored on the optical disc D1 mounted to the video camera 101 are automatically transmitted to the PC 102 to realize the dubbing function for writing the data on the optical disc D2a or D2b.

In this exemplary embodiment as well, when the video camera 101 is not connected to the PC 102, it is desired that the consumption amount of applications occupying the internal memory 302 according to this exemplary embodiment is small. Thus, the program resident in the internal memory 104 is not for all the application programs and can be only for the module C that decides whether or not the application is activated.

It should be noted that for the application of this exemplary embodiment, the device name of the video camera is known or a default value can be used. The USB interface is an interface originally designed as Hot Plug and Play. When the video camera 101 is connected to the USB host connector 307 via the USB cable 104, the mass storage communication is established. This communication establishment procedure is known.

At this time, the OS recognizes the connected device and obtains the device name. The module C according to this exemplary embodiment monitors the event generation in which a device is connected to the USB host connector 307 and executes the process at the time of the USB device connection. Hereinafter, processes of the respective modules A to D will be described.

Description for the Module C (Resident Program)

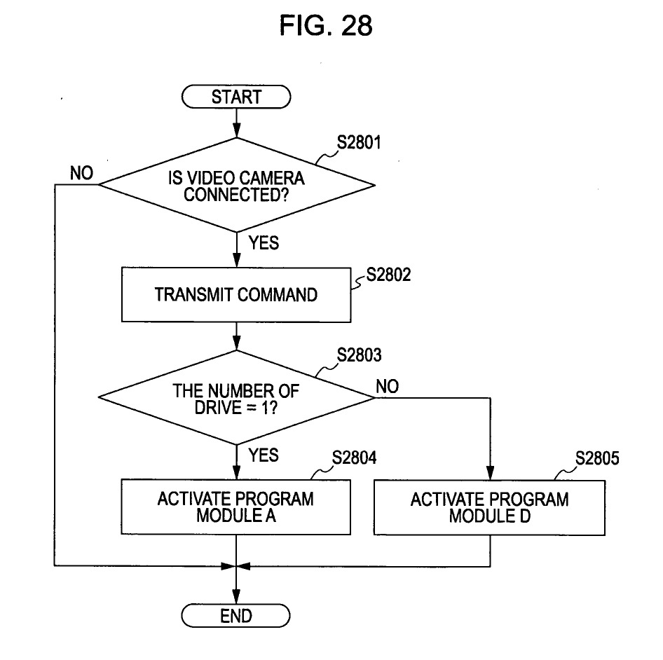

FIG. 28 is a flowchart showing the process steps of the module C according to this exemplary embodiment. This process is, as described above, executed when any device is connected to the connector 307 functioning as the USB host.

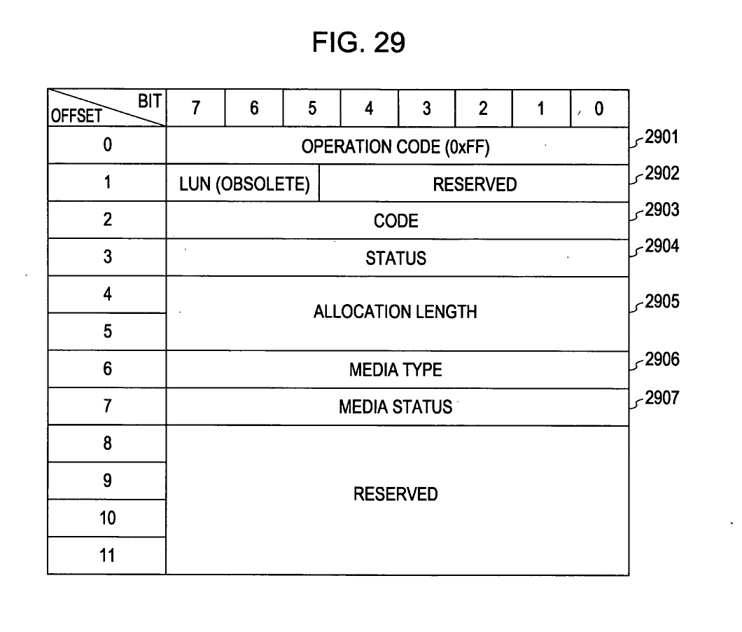

First of all, in Step S2801, it is determined whether or not the connected USB device is a known video camera. When an unknown video camera is connected, this process ends. When it is determined the known video camera 101 is connected and the process proceeds to Step S2802. “NOT READY (7)” is set in a field 2904 in a command A, which can have the data structure shown in FIG. 29, and the command is transmitted to the video camera 101 via the connector 307. This command A includes 12 byte data based on the construction of ATAPI command block.

In the ATAPI standard, a field 2901 at the data offset 0 byte represents command block the control information. However, the function of this exemplary embodiment is not defined under the ATAPI standard, so 0×FF indicating a vendor unique command specifies the control information.

A field 2902 has a structure for specifying a Logical Unit Number in upper 3 bits on the basis of the ATAPI standard. In this exemplary embodiment, 0 is specified. A field 2903 specifies a detailed function of this command. In this exemplary embodiment, 0×01 and 0×02 can be specified. When the video camera 101 is notified of the status of the PC 102 and triggers for the status reception of the video camera 101 and the dubbing and format execution are received, 0×01 is set.

When a plurality of recording/reproduction drives are connected to the PC 102 and when information on the recording/reproduction drive selected by the video camera 101 is acquired, 0×02 is set.

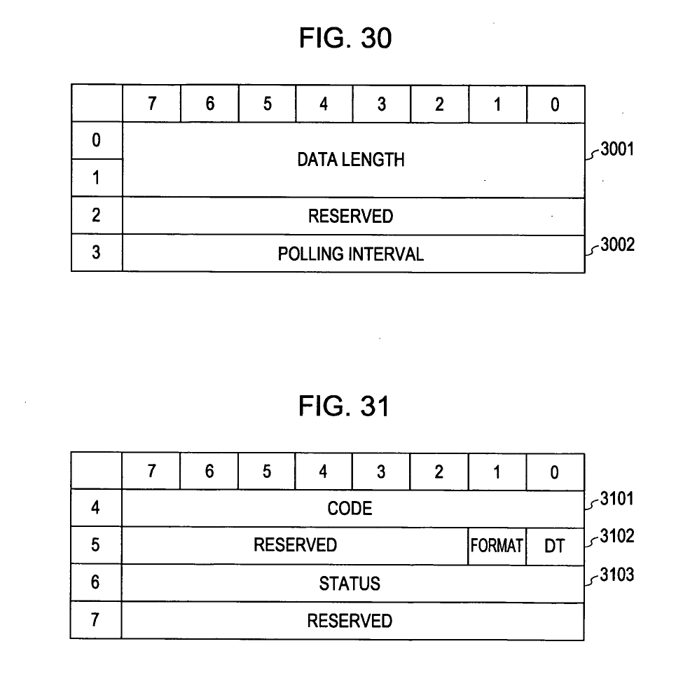

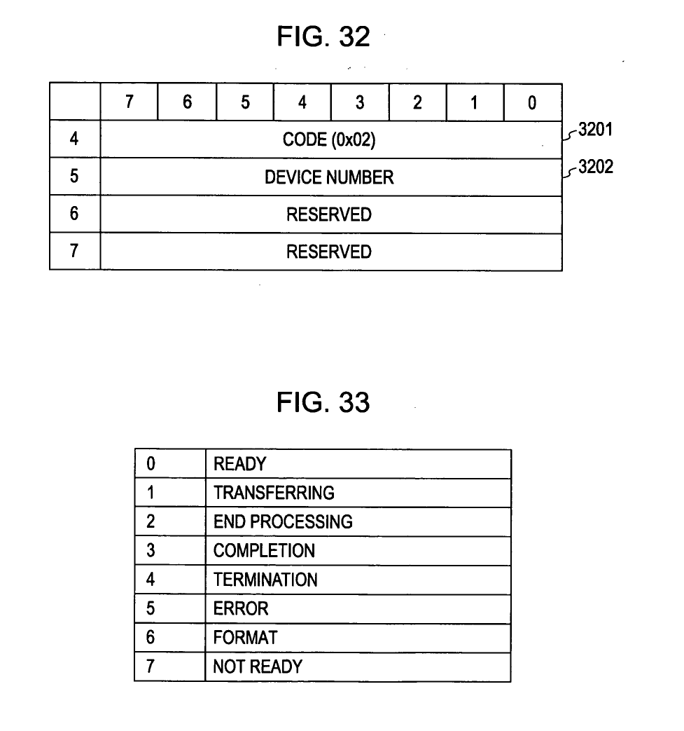

When 0×01 is specified, the header of FIG. 30 and the response data accompanying the data of FIG. 31 are received. When 0×02 is specified, the header of FIG. 30 and the response data including the data fields shown in FIG. 32 are received. FIGS. 30 to 32 will be described below.

The field 2904 is a field which indicates that status information of the PC 102 and values shown in FIG. 33 are set therein. The meaning of each value is as follows.

“READY (0)” indicates that the PC 102 can receive data and recording and storage thereof can be performed. “TRANSFERRING (1)” indicates that the data is being received. “END PROCESSING (2)” indicates that the data has been received to be recorded on the disc D2a or the disc D2b and an end process is being executed. “COMPLETION (3)” indicates that the data has been received and recording on the disc D2a or the disc D2b is completed. “TERMINATION (4)” indicates that the process is interrupted before the data has been received for the data recording and storage. “ERROR (5)” indicates that an error occurs in the process before the data has been received to complete the data recording on the disc D2a or D2b, for example, indicating the process interruption due to occurrence of a writing error. “FORMAT (6)” indicates that the disc D2a or D2b is in the format process. “NOT READY (7)” indicates that a recording/reproduction drive for copying is not selected.

A field 2905 represents a data length of the data acquired from the video camera 101 in the PC 102.

A field 2906 represents the type of the optical disc mounted to the recording/reproduction drive that is connected to the PC 102 and values shown in FIG. 7 are set therein. The meaning of each value is as follows. It should be noted that as illustrated in FIG. 26, when a plurality of recording/reproduction drives are connected to the PC 102, the field 2906 represents the type of the disc mounted to the selected recording/reproduction drive among the plurality of recording/reproduction drives.

“NO MEDIA (0)” indicates that no optical disc is mounted to the recording/reproduction drive that is connected to the PC 102. “NOT SUPPORT (1)” indicates that the optical disc mounted to the recording/reproduction drive that is connected to the PC 102 is not a supported disc. “DVD-R (2)” indicates that the DVD-R optical disc is mounted to the recording/reproduction drive that is connected to the PC 102. “DVD-RW (3)” indicates that the DVD-RW optical disc is mounted to the recording/reproduction drive that is connected to the PC 102. “DVD-RAM (4)” indicates that the DVD-RAM optical disc is mounted to the recording/reproduction drive that is connected to the PC 102. “DVD+R (5)” indicates that the DVD+R optical disc is mounted to the recording/reproduction drive that is connected to the PC 102. “DVD+RW (6)” indicates that the DVD+RW optical disc is mounted to the recording/reproduction drive that is connected to the PC 102.

A field 2907 represents the writing status of the optical disc mounted to the recording/reproduction drive that is connected to the PC 102 and the values shown in FIG. 8 are set therein. The meaning of each value is as follows. It should be noted that as illustrated in FIG. 26, when a plurality of recording/reproduction drives are connected to the PC 102, the field 2907 represents the status of the disc mounted to the selected recording/reproduction drive among these recording/reproduction drives.

“NO MEDIA (0)” indicates that no disc is mounted to the recording/reproduction drive. “BLANK (1)” indicates that the disc mounted to the recording/reproduction drive is a blank disc (disc without any record). “FORMAT PROCESSED (2)” indicates that the disc inserted in the recording/reproduction drive is a formatted disc. “DATA RECORDED (3)” indicates that the disc mounted to the recording/reproduction drive has some data already recorded thereon. “FINALIZED (4)” indicates that the disc mounted to the recording/reproduction drive has been subjected to the end process. “DAMAGED DISC (5)” indicates that the disc mounted to the recording/reproduction drive 3 is a damaged disc (e.g., due to a scratch, data cannot be written on the disc properly or data on the disc cannot be read out properly).

The process returns to the flow of FIG. 28. In Step S2803, it is determined whether or not the number of the recording/reproduction drive connected to the PC 102 is 1. When the number of the recording/reproduction drive is 1, the program module A is activated (Step S2804). On the other hand, as illustrated in FIG. 26, when the connection is achieved among a plurality of recording/reproduction drives, the module D is activated (Step S2805).

It should be noted that in this exemplary embodiment, when the number of the recording/reproduction drive is 1, the module A is activated without the intervention of the module D, but the module D can be activated to transmit the drive information.

Description for the Module D

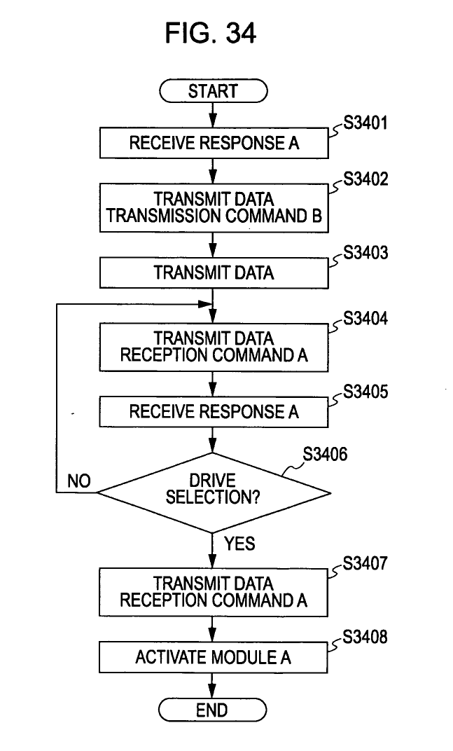

The module D is a module to be executed when a plurality of recording/reproduction drives are connected to the PC 102. A process of the module will be described in accordance with a flowchart of FIG. 34.

First of all, in Step S3401, the response data A issued by the module C in response to the command A is received. The structure of the response data is shown in FIGS. 30 and 31. FIG. 30 illustrates the header part of the response data A and FIG. 31 illustrates the structure when 0×01 is set in the code of the field 2902 in FIG. 29.

In FIG. 30, a field 3001 at the first 2 bytes represents the response data length, and in this exemplary embodiment, the 8-byte length is set. A field 3002 specifies the time for the next command transmission by the PC 102 in about 100 ms unit. In other words, when the value of the field 3002 is set to 1, for example, the PC 102 can be set to transmit the next command in about 100 ms. A field 3003 sets 0×01 in the case of the command A and sets 0×02 in the case of a command B, which will be described later.

Then, a field 3101 of FIG. 31 sets 0×01 indicating a response A. A format bit of a field 3102 is a flag indicating whether or not the user has instructed the format process on the disc D2 mounted to the recording/reproduction drive 103. When the format process has been instructed, 1 is set therein.

The DT of the field 3102 is a flag indicating whether or not the user has operated the dubbing instruction button 209 in the video camera 101. When the button 209 has been operated, 1 is set therein. A detection process of the button 209 will be described later. A field 3103 represents the status of the video camera 101 and the value takes one of the values shown in the table of FIG. 12. The meaning of each value is as follows.

“READY” (0) indicates that the video camera 101 can transmit data. “TRANSFERRING” (1) indicates that data is being transmitted. “BUSY” (2) indicates that the video camera 101 executes another process and cannot response to a command request from the PC 102. “LOW BATTERY” (3) indicates that the battery voltage becomes low during the data transmission. “MODE CHANGE” (4) indicates that the mode of the video camera 101 is changed. “NO DISC” (5) indicates that the disc D1 is not inserted in the video camera 101. “NO READABLE DISC” (6) indicates that the readable optical disc D1 is not inserted in the video camera 101. “NOT READY” (8) indicates that the reply as to whether or not the format process is executed on the recording destination disc D2 is waited for.

It should be noted that in the module D, this response may not be particularly used but can be received for keeping the consistency with the module A.

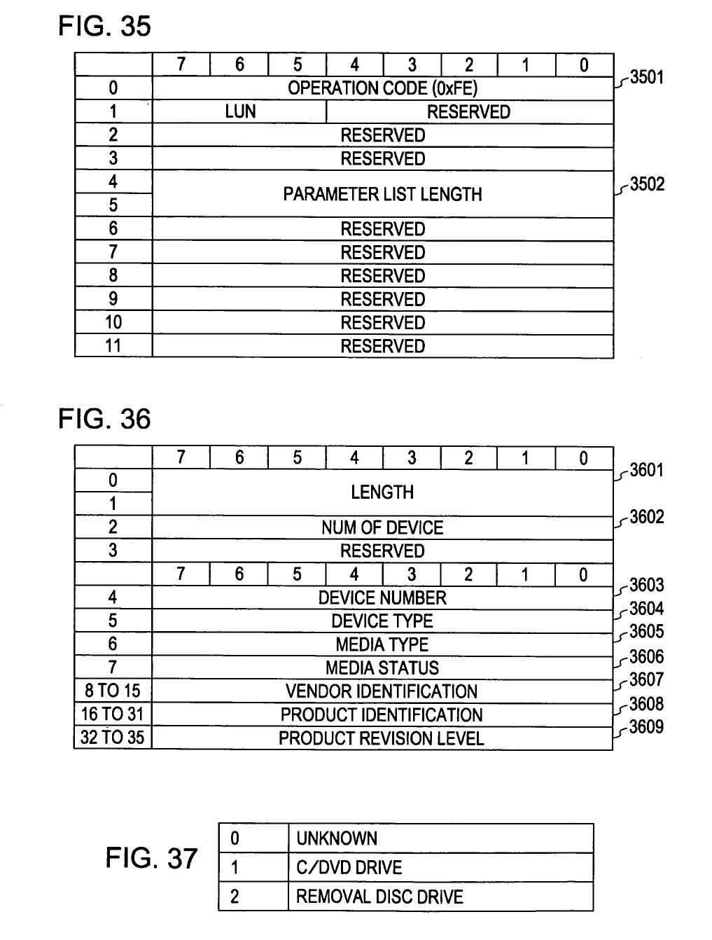

After the response A is received, a command B for transmitting data on a plurality of recording/reproduction drives is transmitted to the video camera 101 with the communication control section 306. The structure of the transmitted command block is shown in FIG. 35.

The command B includes 12 byte data based on the construction of ATAPI command block. In the ATAPI standard, a field 2701 at the data offset 0 byte shows control information of this command block. However, the function of this exemplary embodiment is not defined under the ATAPI standard, so 0×FF indicating a vendor unique command specifies the command information.

A field 3502 represents the data length of a parameter list, namely, the length of data transmitted from the PC 102 after this command is transmitted.

After the command B is transmitted in Step S3402, the data created in accordance with the data structure shown in FIG. 36 is transmitted to the video camera 101 via the USB host connector 307.

A field 3601 of FIG. 36 represents the data length of all the data.

A field 3602 represents the number of the recording/reproduction drives connected to the PC 102. In the structure of FIG. 26, the two recording/reproduction drives 103 and 105 are connected, and therefore 0×02 is set in the value of the code. It should be noted that when a plurality of drives are prepared, data represented by fields 3604 to 3609 of FIG. 36 exists for each drive. It should be noted that in this case information on all the recording/reproduction drives connected to PC 1504 is notified, but the video camera 101 can be notified of information on the recordable recording/reproduction drives.

A field 3603 represents the serial number of the recording/reproduction drive. For example, when two drives are prepared, the first recording/reproduction drive has the device number of 1 and the second recording/reproduction drive has the device number of device number of 2.

A field 3604 represents the device type, which indicates which drive characteristics the device has as illustrated in FIG. 33.

A field 3605 is the same as that of the field 2906 in FIG. 29 and a field 3606 is the same as that of the field 2907.

Fields 3607 to 3609 have the similar length as compared with fields of Vendor Identification, Product Identification, and Product Revision Level, which are obtained from ATAPI INQUIRY commands. The fields can be obtained by issuing the INQUIRY command to the respective connected recording/reproduction drives. The ATAPI INQUIRY command is described in the ATAPI standard, so the description is omitted here.

The field 3607 describes a vendor unique ID, the field 3608 describes a product ID, and the field 3609 indicates a revision number of the product.

After these pieces of data are transmitted, in Step S3403, the command A for setting 0×02 in the code of the field 2902 is transmitted to the video camera 101 in Step S3404.

After the command A has been transmitted, the response A to the command A is received in Step S3405. The response data adopts the structure shown in FIG. 32 when 0×02 is set in the code of the field 2902.

FIG. 32 shows data transmitted along with the header of FIG. 30 and a code 0×02 indicating a response B can be set in a field 3201. A value according to the number of the recording/reproduction drive selected by the user can be set in a field 3202. When none of the recording/reproduction drives are selected, 0 is set therein.

After the response A has been received, the process transits to Step S3406, where it is checked whether or not 1 or higher number is set in the device number of the field 3202. When 1 or higher number is set in the field 3202, this number is the device number of the selected recording/reproduction drive on the video camera 101 side and the specified recording/reproduction drive is selected as the recording destination drive. Then, the process transits to Step S3407. When the status of PC 102 indicates that the writing can be performed, the “READY (0)” command as the command A is issued. When the status of PC 102 indicates that the writing cannot be performed, the “NOT READY (7)” of the command A is issued and thereafter the module A is activated.

It should be noted that when 0 is set in the field 3202 in Step S3406, the process returns to Step S3404 again to transmit the data. The process can be repeated until the recording destination recording/reproduction drive is selected with the digital video camera 101.

In this exemplary embodiment, from now on, a description will be given while it is assumed that the recording/reproduction drive 105 is selected in the recording destination in the module D.

Description for the Module A

The module A is a module to be executed when the video camera 101 and the PC 102 are connected to each other and the recording destination drive is selected.

When module A is activated, the command A of “READY (0)” or “NOT READY (7)” is already transmitted to the video camera 101 beforehand. Once module A is activated, the module A resides in the internal memory 302 during the dubbing operation, and the module A is executed when the response data from the video camera 101 is received as well.

In the process of the module A, a command transmitted to the video camera 101 has a data structure shown in FIG. 29.

As described above, when the module A is activated, the “READY (0)” or “NOT READY (7)” command is already transmitted from the PC 102 to the video camera 101, the reply (response data) is returned from the video camera 101.

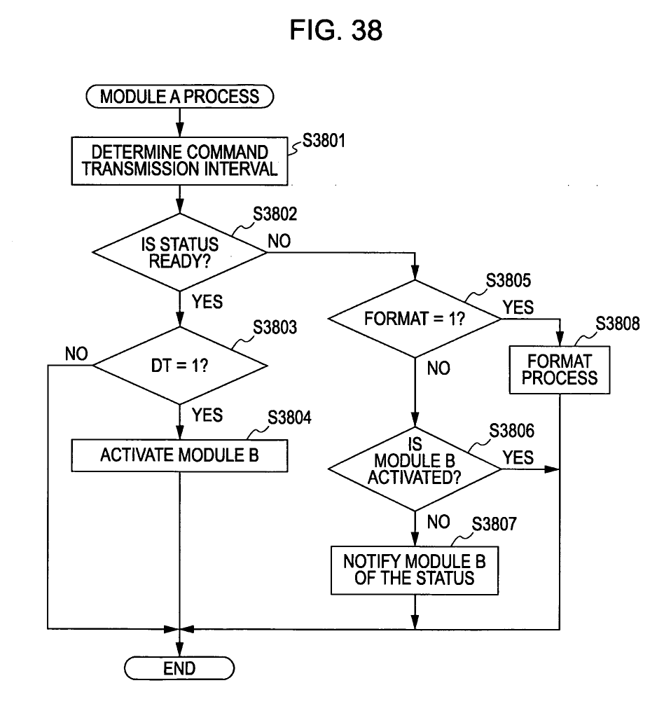

Furthermore, as will be described below, even during the dubbing, the response data is returned from the video camera 101, in that case as well, a process in accordance with this response data is executed. In keeping with the above-mentioned point, the process of the module A will be described in accordance with a flowchart of FIG. 38.

First of all, in Step S3801, the transmission time for transmitting a command for the next time can be set in accordance with the value in the field 3102 of the received response data. When the transmission time is set, the command transmission process (FIG. 10) forming the module A is executed after waiting for the set transmission time.

As illustrated in FIG. 10, in the command transmission process, a status is acquired in Step S1001 and the acquired status is transmitted to the video camera 101 as the data structure command shown in FIG. 29 in Step S1002. Thus, as the response data is returned from the video camera 101, the process is executed each time.

Now, FIG. 38 is described again. The setting of the activation timing for the command transmission can be performed in Step S3802 to check the status of the PC 102. When the PC 102 is “READY (O)”, the video camera 101 is in a status where transmission of the image data can be performed and the process transits to Step S3803.

In Step S3803, a response data field (the field 3102 of FIG. 31) is checked and it is determined whether or not the DT bit is set to 1. As the detail will be described later, when the dubbing start instruction button is pressed down in the video camera 101, 1 is set in the DT bit. When 1 is set in the DT bit, the process transits to Step S3804. Then, the module B for reading the data recorded on the disc D1 mounted to the video camera 101 and writing data on the discs D2a and D2b (dubbing) is activated to end the process.

On the other hand, in Step S3802, when the status of the PC 102 is not “READY (0)”, the process transits to Step S3805. Similarly to the DT bit, the format bit in the response data field 3102 of FIG. 31 is checked. Here, as will be described below, when the format process is instructed for the disc D2b mounted to the recording/reproduction drive 105 that is selected as the recording destination by the video camera 101, 1 is set in the format bit. When 1 is set in the format bit, the process transits to Step S3808, where the format process is executed on the selected drive (the recording/reproduction drive 105).

It should be noted that during the format process, in the transmission of the command A in Step S1002 of FIG. 10, the value of the field 2903 is set as “FORMAT (6)” and transmitted to the video camera 101. After the resetting, in the transmission of the command A in Step S1002, the value of the field 2903 is set as “READY (0)”.

In Step S3806, when the format bit is 0, the process transits to Step S3606 and it is determined whether or not the module B is activated. When the module B is activated, in Step S3807, the module B is notified of the status and the process is finished. On the other hand, in Step S3806, when the module B is not activated, the process is finished.

It should be noted that the description is out of sequence, the OS operating on the PC 102 is a multitask OS and the modules A and B individually operate as a separate task.

Description for the Module B

A process of the module B is the same as the process shown in the flowchart of FIG. 11 according to the first exemplary embodiment, so the detailed description is omitted. In this exemplary embodiment, the difference resides in that the data received from the video camera 101 can be recorded on a disc mounted to a selected drive between the drives 103 and 105. The recording destination drive is already selected in the module D, and therefore the data can be recorded on the disc that is mounted to the drive selected in the module D.

Process of the Video Camera 101

Next, the process of the video camera 101 according to this exemplary embodiment will be described.

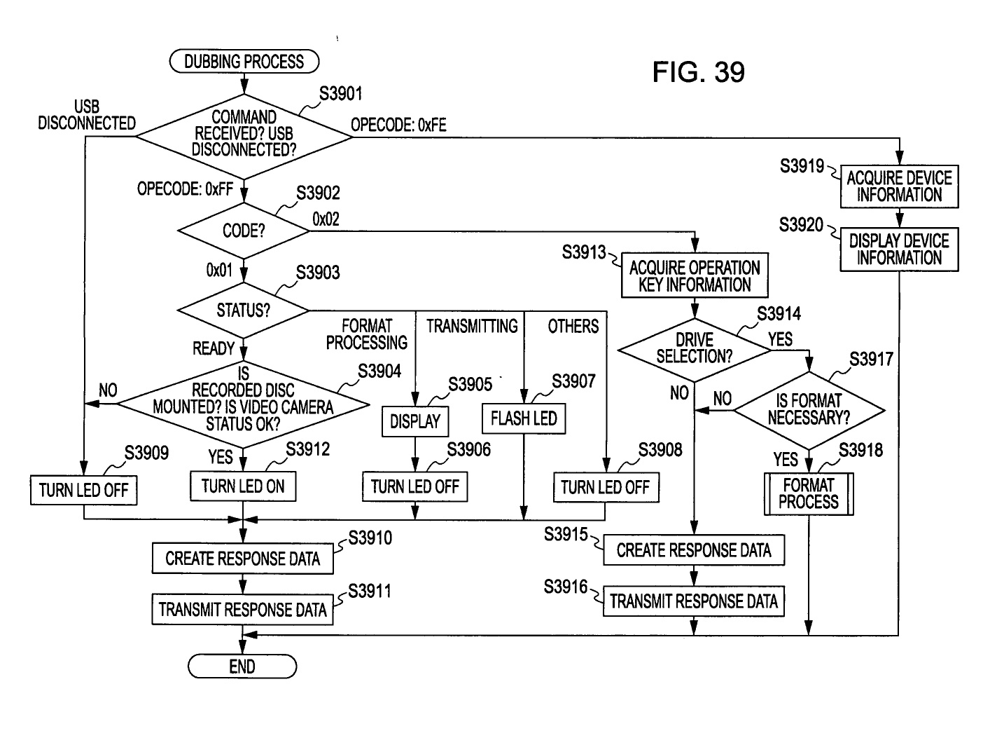

With reference to a flowchart of FIG. 39, a description will be given of the process to be executed by the main control section 203 according to the notification from the communication control section 204 in the status where the video camera 101 is connected to the PC 102 via the USB cable 104 to establish the connection.

In Step S3901, the main control section 203 determines whether or not the command is received from the PC 102 via the communication control section 204 or whether or not the USB cable is disconnected (for example, the USB cable is pulled out from the connector). When it is determined that the USB cable is disconnected, the process proceeds to Step S3909, where the LED of the button 209 is turned off.

Also, in Step S3901, when the operation code of the received command is 0×FF as illustrated in FIG. 29, the process transits to Step S3902. Then, as illustrated in FIG. 35, when the operation code is 0×FE, the process transits to Step S3919. As described above, when the operation code is 0×FE, the received command is the command B to notify the drive information.

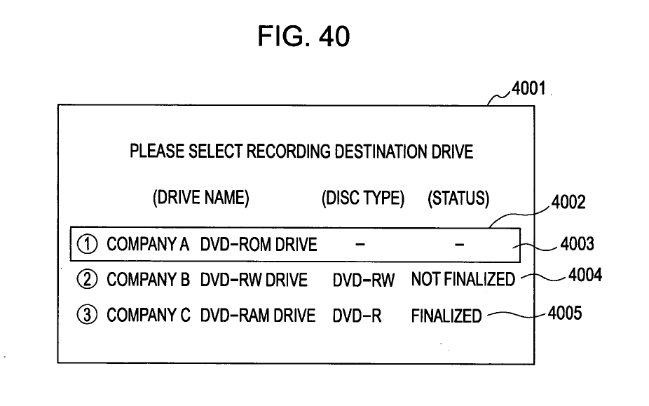

In Step S3901, when the command B is received, in Step S3919, the main control section 203 obtains attribute information on the recording/reproduction drive. Then, in Step S3920, on the basis of the obtained drive attribute information, as illustrated in FIG. 40, information 4001 on the writing destination drive connected to the PC 102 and the disc mounted to the drive is displayed on the display section 211. It should be noted that in FIG. 40, information on a drive having no writable disc mounted thereto is displayed as well, but it is also possible that information is on a drive having a writable disc mounted thereto is displayed.

In this way, after the device information is transmitted from the PC 102, as illustrated in FIG. 29, the command A where the operation code in the field 2901 is set as 0×FF and the value in the field 2902 is set as 0×02 is transmitted from the PC 102.

For this reason, the process transits from Step S3901 to Step S3902 and after that the process proceeds to Step S3913.

In Step S3913, on the basis of information on a recording/reproduction device list, recording/reproduction drive list information is displayed. FIG. 40 shows a display screen example of the recording/reproduction drive list.

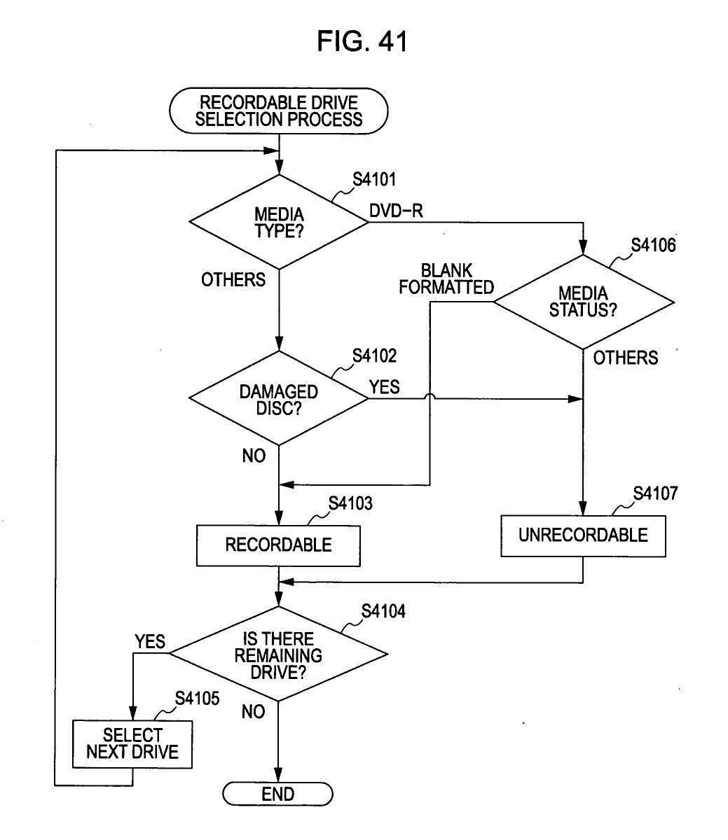

At this time, in this exemplary embodiment, drives having writable optical discs mounted thereto and other drives are discriminated on the basis of the device information. To be specific, as illustrated in the flowchart of FIG. 41, first of all, in Step S4101, for one of plural pieces of the recording/reproduction drive information, the type of the mounted disc is discriminated.

When the mounted disc is other than DVD-R, in Step S4102, it is determined whether or not the disc is a damaged disc. When the disc is not a damaged disc, in Step S4103, the disc is set in the recordable drive. Also, when the disc is a damaged disc, in Step S4107, the disc can be set in the nonrecordable drive. Then, in Step S4104, it is determined whether or not there is remaining drive information.

Furthermore, in Step S4101, when the disc is DVD-R, in Step S4106, it is determined whether or not the disc status is a blank disc where no data is recorded thereon and formatted. When the disc is a blank disc and formatted, in Step S4103, the disc can be set in the recordable drive. Also, when the disc is not a blank disc or the disc is not formatted, in Step S4107, the disc can be set in the nonrecordable drive.

In Step S4104, when remaining drive information exists, in Step S4105, the next drive information is selected and the process returns to Step S4101. When the discrimination process for all the drive information has been completed, the process is finished.

The user moves a selection frame 4002 shown in FIG. 40 by operating the operation section 208, thereby making it possible to select the writing destination drive. Then, in this exemplary embodiment, in accordance with the discrimination result of FIG. 41, a drive list screen display mode is changed so that only drives having recordable discs mounted thereto can be selected. To be specific, the selection frame 4002 is allowed to be moved to the drives having recordable discs mounted thereto.

For example, in the example of FIG. 40, as a writable optical disc is mounted only to a second drive 4004, the selection frame 4002 can only select the second drive 4004. By setting a thin color for characters of unselectable drives 4003 and 4005, for example, the user can be informed that some drives cannot be selected.

In this way, in Step S3913, the drive list information is displayed so that the user can select a drive. Thus, when a rewritable optical disc like DVD-RW which is not finalized to the recording destination drive but which is not a blank disc is selected (in the case of a blank disc, “a blank disc” is displayed), the format process can be performed.

Thus, in Step S3914, it is determined whether or not a drive has been selected. When any drive has not been selected yet, or in Step S3917 when a disc requiring no format process is mounted to the selected drive, the process transits to Step S3915 to generate the response data. Here, as described above, 8-byte data structured by 4-byte data of FIG. 30 added as the header part and 4-byte data shown in FIG. 32 is transmitted.

At this time, the value 0×02 shown in the field 2902 is set in the field 3201 and the value corresponding to the device number selected by the user in Step S3913 is set in the field 3202. Here, when the device number is not selected by the user, 0 is set. For example, when the second device 4004 in FIG. 40 is selected, the value 2 is set.

In this manner, the response data is generated and transmitted to the PC 102 in Step S3915.

On the other hand, in Step S3917, when a format required disc is mounted, the process transits to Step S3918 to execute the format process.

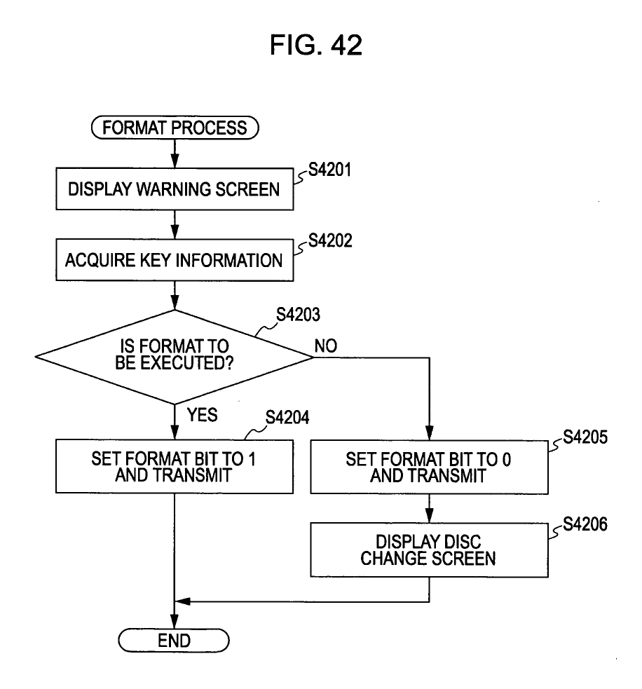

FIG. 42 is a flowchart showing the format process.

It should be noted that in this exemplary embodiment, the command A where the field 2902 is always set as 0×01 is transmitted at constant intervals. In FIG. 42, in this way, as the response A to the command A, which is transmitted at constant intervals, information indicating whether or not the format process is necessary can be transmitted to the PC 102.

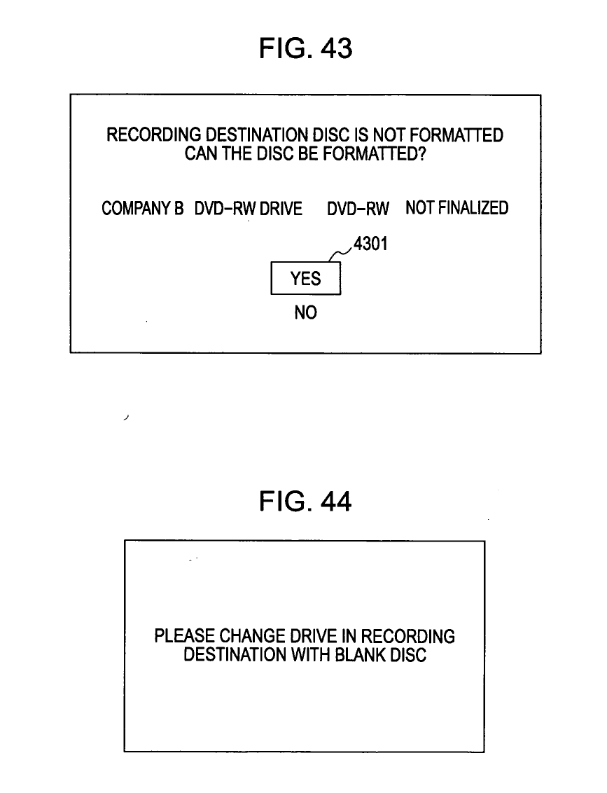

First of all, in Step S4201, the warning screen shown in FIG. 43 is displayed on the display section 211. The user moves the selection frame 4301 shown in FIG. 43 by operating the operation section 208 to select whether or not the format process is executed. Then, in Step S4202, the selection result of the user is obtained and in Step S4203, it is determined whether or not the format process is executed. When the format process is executed, in Step S4204, 1 is set in the format bit of the field 3102 to issue a reply to the PC 102. Thus, the format process is started in the PC 102 and the formatting status is achieved.

On the other hand, in Step S4203, when NO is selected, in Step S4205, 0 is set in the format bit of the field 3102, and in Step S4206, a screen shown in FIG. 44 for urging the disc change is displayed on the display section 211.

Now, the process flow during the format will be described with reference to FIG. 39 again.

When the format process is executed in the PC 102, the command A where the field 2902 is set as 0×01 is transmitted from the PC 102. For this reason, the process proceeds to Step S3903 via Steps S3901 and S3902. Then, in Step S3903, the status in the field 2903 of the received command A is checked. In this case, the field 2903 is set as “FORMAT (6)”.

Therefore, the process transits to Step S3905 to display information on the display section 211 indicating that the format process is being executed. Then, in Step S3906, the LED of the input button 209 is turned off. When the turning off of the LED is completed, the process transits to Step S3910 to generate the response data. Step S3910 will be described below.

With the series of processes described above, the drive selection and the format process are finished, whereby it is possible to execute the disc dubbing.

Next, in Step S3903, the case where the field 2903 is set as “READY (0)” will be described. In this case, the command A where the field 2902 is set as 0×01 is transmitted from the PC 102. For this reason, the process proceeds to Step S3903 via Steps S3901 and S3902. Then, in Step S3903, the status in the field 2903 of the received command A is checked.

In Step S3903, the command A where the field 2903 is set as “READY (0)” is received, the process proceeds to Step S3904. Then, it is determined whether or not the dubbing source disc D1 is properly mounted to the video camera 101 and whether or not the image data is recorded on the optical disc D1. Also, at this time, it is also determined whether or not an electric power source of the video camera 101 is in an appropriate status and in an appropriate mode.

For example, the transfer band of the USB interface (e.g., High Speed Mode in USB. ver 2.0) is about 480 Mbps and sufficiently fast. The disc D1 is rotated at a higher speed as compared with the normal filming to read out the data and the data can be transferred to the PC 102.

Therefore, when the video camera 101 is in a filming mode, dubbing to the PC 102 cannot be performed. Here, the appropriate mode is a mode where no access is made to the optical disc D1.

In Step S3904, when the recorded disc D1 is mounted and it is determined that the status is not a low battery status (LOW BATTERY) and the mode is appropriate, the process proceeds to Step S3912. To inform that the dubbing can be started, the LED of the button 209 is turned on.

On the other hand, the video camera 101 is not “READY (0)”, the process transits to Step S3909 to turn the LED of the button 209 off.

In Step S3912, after the LED is turned on, a response data field 3103 generated in Step S3910 is set as “READY (0)” indicating that the video camera 101 can transmit data.

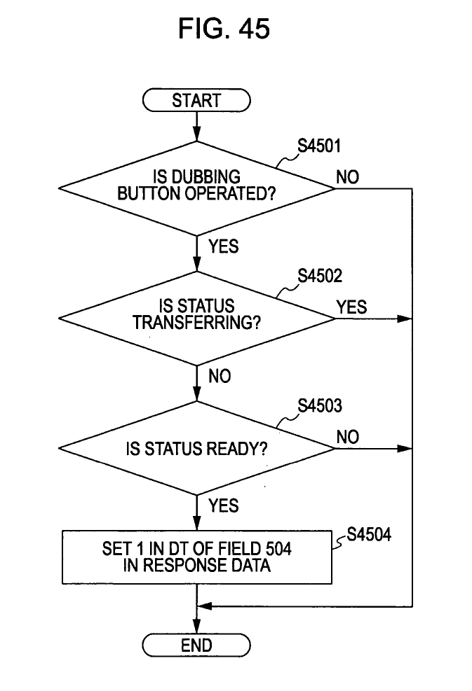

At this time, in a process of FIG. 45 to be described later, when 1 is set in the DT of the field 3102 bit (when the user presses down the dubbing button 209), a response corresponding to the setting is generated.

The response data generated in this manner is transmitted to the PC 102 in Step S3911 and the process is finished. It should be noted that when the response data is transmitted, the response data is stored in the internal memory 206 until the next response data is transmitted. In other words, the response data is generated by updating the previous response data.

On the other hand, in Step S3904, when the status is not “READY (0)”, 0 is set in the DT of the field 3102 bit irrespectively as to whether the input button 209 is pressed down or not.

In Step S3903, when the status field 2904 of the command from the PC 102 is “TRANSFERRING (1)” or “END PROCESSING (2)”, the process proceeds to Step S3907, where the LED of the button 209 is flashed to inform the user that the transfer is being performed.

Alternatively, in Step S3903, when the command status field 2904 from the PC 1504 is “COMPLETION (3)”, “TERMINATION (4)”, “ERROR (5)”, or “NOT READY (7)”, in Step S3908, the LED of the button 209 is turned off.

Next, a detection process for the user input process in the video camera 101 will be described in accordance with a flowchart of FIG. 45. This process is asynchronously executed with respect to the process of FIG. 39. This process can be performed by software executed by the main control section 203, but if the response to the user is conducted at a high speed, the process can be realized by hardware interruption.

When any button of the operation section 208 is operated, this process is started.

First of all, in Step S4501, it is determined whether or not the operated button is the dubbing button 209. When the operated button is not the dubbing button, the process is finished. When the dubbing button 209 is operated, the process proceeds to Step S4502, to check the status of the updated response data stored in the internal memory 206 and it is determined whether or not the status is “TRANSFERRING”. When the status is “TRANSFERRING”, the status means that the image data transfer has been already performed, the process is finished.

On the other hand, when it is determined that the status is not “TRANSFERRING”, the process proceeds to Step S4503 and it is determined whether or not the response data status is READY. When the status is READY, the status means that the video camera 101 and the PC 102 wait for the dubbing instruction as the dubbing conditions are met, the process proceeds to Step S4504. Then, the DT of the response data field 3102 in the internal memory 206 is set to 1.

Thus, in the process of FIG. 39, when a command is received from the PC 102 next time, the response data where the DT of the field 3102 is set as 1 is generated in Step S3910 of FIG. 39, whereby the notification informing that the dubbing instruction is issued to the PC can be made.

In this exemplary embodiment as well, related to the first exemplary embodiment, after the dubbing has been started, the value in the field 3002 can be set smaller than before. To be specific, for example, when about 100 ms is set before the dubbing instruction, the value is substantially halved, that is, about 50 ms when the dubbing instruction is issued.

As has been described above, in this exemplary embodiment as well, when the data recorded on the disc D1 is reproduced by the video camera and transmitted to the PC and dubbing is performed on another disc by using a plurality of recording/reproduction drives connected to the PC, information indicating the status of the respective recording/reproduction drives and the status of the mounted disc is transmitted to the video camera, and the status of the respective recording/reproduction drives are displayed on the display section of the video camera. Then, the user can select the recording destination recording/reproduction drive and instruct the dubbing only by operating the video camera while checking the status of the respective recording/reproduction drives displayed on the video camera. Also, the video camera can function as the mass storage of the PC and the image file transfer to the PC can be performed, as though, under the control of the video camera.

It should be noted that in this exemplary embodiment, among a plurality of recording/reproduction drives connected to the PC, a drive having no disc mounted thereto is also displayed on the drive list screen. However, the display of the information about a drive having no disc mounted thereto can be prohibited.

Furthermore, among a plurality of recording/reproduction drives connected to the PC, a drive having no writable disc mounted thereto is also displayed on the drive list screen. However, the information about a drive, which can have a writable disc mounted thereto, can be displayed on the drive list screen.

The feature of the process by the PC is based on the application program, so it is obvious that the present invention encompasses the program computer. Also, the application program of the PC according to the embodiment is bundled with a CD-ROM that is attached to the video camera. Then, this CD-ROM (computer readable memory medium) can be set in the PC to copy or install the application program in the system, thereby making it possible to execute the application program according to this exemplary embodiment. Thus, such a computer readable memory medium is of course within the scope of the present invention as well.

While the present invention has been described with reference to exemplary embodiments, it can be understood that the invention is not limited to the discussed exemplary embodiments. The scope of the following claims can be accorded the broadest interpretation so as to encompass all modifications, equivalent structures and functions.

This application claims the benefit of Japanese Applications No. 2005-171006 filed Jun. 10, 2005 and No. 2006-102091 filed Apr. 3, 2006, which are hereby incorporated by reference herein in their entirety.

What is claimed is:

1. A reproduction apparatus communicable via a transmission path with a signal processing device that records data on a second disc recording medium by controlling a recoding device, comprising:
a reproduction device configured to reproduce image data from a first disc recording medium;
an instruction device configured to instruct the signal processing device to transmit the image data reproduced by the reproduction device to be recorded on the second disc recording medium, the second disc recording medium including a rewritable recording medium on which data can be repeatedly overwritten and a write once recording medium;
a communication device configured to receive disc status information related to the second disc recording medium from the signal processing device, the disc status information including information indicating whether the second disc recording medium is the rewritable recording medium or the write once recording medium;
a determining device configured to determine whether or not the image data can be recorded on the second disc recording medium on the basis of the disc status information;
a display device configured to display a determination result of the determining device and the disc status information; and
a control device configured to control the reproduction device to reproduce the image data from the first disc recording medium in accordance with an instruction from the instruction device and control the communication device to transmit the reproduced image data to the signal processing device.

2. An apparatus according to claim 1, wherein:
the disc status information further includes information as to whether or not the second disc recording medium has been subjected to a finalizing process; and
the determining device determines that the image data cannot be recorded on the second disc recording medium when the second disc recording medium is the write once recording medium and has been subjected to the finalizing process.

3. An apparatus according to claim 1, wherein:
the disc status information further includes information indicating that the image data is not recorded on the second disc recording medium; and
the determining device determines that the image data cannot be recorded on the second disc recording medium the second disc recording medium is the write once recording medium and the image data has been recorded on the second disc recording medium.

4. An apparatus according to claim 3, wherein the display device displays inquiry information as to whether or not a format process is executed on the second disc recording medium when the second disc recording medium is a rewritable recording medium and the image data has been recorded on the second disc recording medium.

5. A reproduction apparatus communicable via a transmission path with a signal processing device that records data on a second disc recording medium by controlling a recoding device, comprising:
a reproduction device configured to reproduce image data from a first disc recording medium;
an instruction device configured to instruct the signal processing device to transmit the image data reproduced by the reproduction device to be recorded on the second disc recording medium;
a communication device configured to receive disc status information related to the second disc recording medium from the signal processing device via the transmission path, the disc status information including information indicating whether the second disc recording medium subjected to a finalizing process;
a determining device configured to determine whether or not the image data can be recorded on the second disc recording medium on the basis of the disc status information;
a display device configured to display a determination result of the determining device and the disc status information; and
a control device configured to control the reproduction device to reproduce the image data from the first disc recording medium in accordance with an instruction from the instruction device and control the communication device to transmit the reproduced image data to the signal processing device.

6. An apparatus according to claim 5, wherein:
the second disc recording medium includes a rewritable recording medium on which data can be repeatedly overwritten and a write once recording medium;
the disc status information includes information as to whether the second recording medium is the rewritable recording medium or the write once recording medium; and
the determining device determines that the image data cannot be recorded on the second disc recording medium when the second disc recording medium is the write once recording medium and has been subjected to the finalizing process.

7. A reproduction apparatus communicable via a transmission path with a signal processing device that records data on a second disc recording medium by controlling a recoding device, comprising:
a reproduction device configured to reproduce image data from a first disc recording medium;
an instruction device configured to instruct the signal processing device to transmit all the image data recorded on the first disc recording medium to be recorded on the second disc recording medium;
a communication device configured to receive disc status information related to the second disc recording medium from the signal processing device, the disc status information including information indicating whether or not image data has been recorded on the second disc recording medium;
a determining device configured to determine whether or not the image data can be recorded on the second disc recording medium on the basis of the disc status information, the determining device determining that the image data can be recorded on the second disc recording medium when none of the image data can be recorded on the second disc recording medium;
a display device configured to display a determination result of the determining device and the disc status information and the disc status information; and
a control device configured to control the reproduction device to reproduce all the image data recorded on the first disc recording medium and control the communication device to transmit the reproduced image data to the signal processing device, in response to the instruction from the instruction device, when the determining device determines that the image data can be recorded on reproduction device configured to the second disc recording medium.

8. A reproduction apparatus communicable via a transmission path with a signal processing device that records data on a plurality of second disc recording media by controlling a plurality of recoding devices, comprising:
a reproduction device configured to reproduce image data from a first disc recording medium;
an instruction device configured to instruct the signal processing device to transmit the image data reproduced by the reproduction device to be recorded on the second disc recording media;
a communication device configured to receive disc status information related to the second disc recording media from the signal processing device, the disc status information including information indicating whether or not the second recording media are mounted to the plurality of recoding devices;
a display device configured to display the disc status information on a display device;
a selection device configured to arbitrarily select one of the plurality of recoding devices by using the disc status information displayed on the display device;
a control device configured to control the reproduction device to reproduce the image data from the first disc recording medium and control the communication device to transmit the selection information indicating the recording device selected by the selecting device and the reproduced image data to the signal processing device so that the selected recording device records the image data on the second disc recording medium in response to the instruction from the instruction device.

9. An apparatus according to claim 8, wherein the selection device prohibits the selection of a recording device on which the second disc recording medium is not mounted amount the plurality of recoding devices.

10. A reproduction apparatus communicable via a transmission path with a signal processing device that records data on a plurality of second disc recording media by controlling a plurality of recoding devices, comprising:
a reproduction device configured to reproduce image data from a first disc recording medium;
an instruction device configured to instruct the signal processing device to transmit the image data reproduced by the reproduction device to be recorded on the second disc recording media;
a communication device configured to receive disc status information related to the second disc recording media from the signal processing device, the disc status information including information indicating whether or not the second recording media are writable;
a display device configured to display the disc status information on a display device;
a selection device configured to arbitrarily select one of the plurality of recoding devices by using the disc status information displayed on the display device;
a control device configured to control the reproduction device to reproduce the image data from the first disc recording medium and control the communication device to transmit the selection information indicating the recording device selected by the selecting device and the reproduced image data to the signal processing device so that the selected recording device records the image data on the second disc recording medium in response to the instruction from the instruction device.

11. An apparatus according to claim 10, wherein the selection device prohibits the selection of a recording device on which the writable second disc recording medium is not mounted among the plurality of recoding devices.

12. A reproduction apparatus communicable via a transmission path with a signal processing device that records data on a second disc recording medium by controlling a recoding device, comprising:
a reproduction device configured to reproduce image data from a first disc recording medium;
a communication device configured to transmit the image data reproduced by the reproduction device so that the image data recorded on the first disc recording medium can be recorded on the second disc recording medium in response to a command from the signal processing device, the communication device transmitting a response including status information about an operational status of the reproduction apparatus and transmission time information indicating the time at which the signal processing device transmits the command for the next time to the signal processing device in response to the command from the signal processing device can be recorded, the signal processing device transmitting the command at a timing in accordance with the transmission time information;
an instruction device configured to instruct the recording start of the image data on the second disc recording medium by the recording device; and
a control device configured to control the reproduction device to reproduce the image data from the first disc recording medium in response to the instruction device and control the communication device to transmit the image data and the reproduced image data via the transmission path to the signal processing device to be recorded on the second disc recording medium, the communication device setting the transmission time so that the transmission interval for the command from the signal processing device after the instruction has been issued is shorter than the transmission interval for the command from the signal processing device before the instruction is to be issued from the instruction device.

13. An apparatus according to claim 12, wherein the status information includes at least one of information indicating that the communication device is transmitting the image data, information indicating that an electric power of a battery for supplying an electric power to the reproduction apparatus is low, and information indicating that response to the command is not possible.
